(19) United States
(12) Patent Application Publication
(10) Pub. No.: US 2025/0173078 A1
(43) Pub. Date: May 29, 2025

(54) SYSTEM AND METHODS FOR USING A DEVICE AS A SWAP AREA

(71) Applicant: Samsung Electronics Co., Ltd., Suwon-si (KR)

(72) Inventors: Mohammadreza SOLTANIYEH, Sunnyvale, CA (US); Ramdas KACHARE, Pleasanton, CA (US); Hingkwan HUEN, Daly City, CA (US); Xuebin YAO, San Diego, CA (US); Caroline Diana KAHN, San Jose, CA (US)

(21) Appl. No.: 18/954,500

(22) Filed: Nov. 20, 2024

Related U.S. Application Data
(60) Provisional application No. 63/604,174, filed on Nov. 29, 2023.
(60) Provisional application No. 63/697,437, filed on Sep. 20, 2024.

(51) Int. Cl. G06F 3/06

(52) U.S. Cl. CPC G06F 3/0634; G06F 3/0604; G06F 3/0659; G06F 3/0673

(57) ABSTRACT

A device is disclosed. The device may include a memory to store a data, a controller to manage the memory, and a storage media to store a copy of the data. A module may support page swapping with a memory associated with a processor.

### RELATED APPLICATION DATA

This application claims the benefit of U.S. Provisional Patent Application Ser. No. 63/604,174, filed Nov. 29, 2023, and of U.S. Provisional Patent Application Ser. No. 63/697,437, filed Sep. 20, 2024, both of which are incorporated by reference herein for all purposes.

### FIELD

The disclosure relates generally to storage, and more particularly to more efficient page swapping.

### BACKGROUND

Ideally, a computer would include sufficient memory to store all relevant data for use by the processor. But in practice, the cost of memory may provide a limit to how much memory a computer may include.

If there is insufficient memory in the computer to store all the relevant data, then the computer may swap pages between memory and a persistent storage device (or any other large capacity, low cost, and likely low performance memory device) as needed, moving pages of memory that are not being used much into the persistent storage device, and bringing into memory pages that are being used more. But the time required to access pages from the persistent storage device may be sufficiently slower than memory that applications may be affected by the delay as pages are moved in and out of memory.

A need remains to manage page swaps more efficiently.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a machine including a device to act as a swap space, according to embodiments of the disclosure.

FIG. 2 shows details of the machine of FIG. 1, according to embodiments of the disclosure.

FIG. 3 shows how pages in the memory of FIG. 1 may be managed, according to embodiments of the disclosure.

FIG. 4A shows a first example configuration of the device of FIG. 1, according to embodiments of the disclosure.

FIG. 4B shows a second example configuration of the device of FIG. 1, according to embodiments of the disclosure.

FIG. 5 shows details of the storage unit of FIG. 4A, according to embodiments of the disclosure.

FIG. 6 shows messages being exchanged between the processor of FIG. 1 and the device of FIG. 1, according to embodiments of the disclosure.

FIG. 7 shows a flowchart of an example procedure for the device of FIG. 1 to be used as a disk for use as swap space for the memory of FIG. 1, according to embodiments of the disclosure.

FIG. 8 shows a flowchart of an example procedure for the device of FIG. 1 to configure itself as a disk for use as a swap space for the memory of FIG. 1, according to embodiments of the disclosure.

FIG. 9 shows a flowchart of an example procedure for the device of FIG. 1 to process a read request from the processor of FIG. 1, according to embodiments of the disclosure.

FIG. 10 shows a flowchart of an example procedure for the device of FIG. 1 to process a write request from the processor of FIG. 1, according to embodiments of the disclosure.

FIG. 11 shows a flowchart of an example procedure for the processor of FIG. 1 to request that the device of FIG. 1 be used as a disk as a swap space for the memory of FIG. 1, according to embodiments of the disclosure.

FIG. 12 shows a flowchart of an example procedure for the processor of FIG. 1 to request that the device of FIG. 1 configure itself as a disk for use as a swap space for the memory of FIG. 1, according to embodiments of the disclosure.

FIG. 13 shows a flowchart of an example procedure for the processor of FIG. 1 to issue a read request to the device of FIG. 1, according to embodiments of the disclosure.

FIG. 14 shows a flowchart of an example procedure for the processor of FIG. 1 to issue a write request to the device of FIG. 1, according to embodiments of the disclosure.

FIG. 15 shows a flowchart of an example procedure for the device of FIG. 1 to be used as a memory extension for use as swap space for the memory of FIG. 1, according to embodiments of the disclosure.

FIG. 16 shows a flowchart of an example procedure for the device of FIG. 1 to configure itself as a memory extension for use as a swap space for the memory of FIG. 1, according to embodiments of the disclosure.

FIG. 17 shows a flowchart of an example procedure for the device of FIG. 1 to perform page swap management in the memory of FIG. 1, according to embodiments of the disclosure.

FIG. 18 shows a flowchart of an example procedure for the device of FIG. 1 to perform a direct memory access to transfer data in or out of the memory of FIG. 1, according to embodiments of the disclosure.

FIG. 19 shows a flowchart of an example procedure for the device of FIG. 1 to perform decompression/decryption of data in response to a read request from the processor of FIG. 1, according to embodiments of the disclosure.

FIG. 20 shows a flowchart of an example procedure for the device of FIG. 1 to perform compression/encryption of data in response to a write request from the processor of FIG. 1, according to embodiments of the disclosure.

FIG. 21 shows a flowchart of an example procedure for the device of FIG. 1 to execute a preload request from the processor of FIG. 1, according to embodiments of the disclosure.

FIG. 22 shows a flowchart of an example procedure for the device of FIG. 1 to return an entry in the page table of FIG. 3 in response to a request from the processor of FIG. 1, according to embodiments of the disclosure.

FIG. 23 shows a flowchart of an example procedure for the device of FIG. 1 to update the metadata of FIG. 4A in response to a request from the processor of FIG. 1, according to embodiments of the disclosure.

FIG. 24 shows a flowchart of an example procedure for the processor of FIG. 1 to request that the device of FIG. 1 be used as a memory extension as a swap space for the memory of FIG. 1, according to embodiments of the disclosure.

FIG. 25 shows a flowchart of an example procedure for the processor of FIG. 1 to request that the device of FIG. 1 configure itself as a memory extension for use as a swap space for the memory of FIG. 1, according to embodiments of the disclosure.

FIG. 26 shows a flowchart of an example procedure for the processor of FIG. 1 to process a request from the device of FIG. 1 to swap a page in the memory of FIG. 1, according to embodiments of the disclosure.

FIG. 27 shows a flowchart of an example procedure for the processor of FIG. 1 to send the processing request of FIG. 6 to the device of FIG. 1, according to embodiments of the disclosure.

### SUMMARY

A device may be used as a swap space for memory associated with a processor. The device may store data in a first memory and may include a controller to manage the first memory. A module may support page swapping with the memory associated with the processor.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Typically, computer systems include both persistent storage devices and memory, which may be volatile. While memory tends to be relatively faster, memory also tends to be more expensive per unit of storage than persistent storage devices.

Ideally, the computer system includes enough memory to store all applications and relevant data. But from a practical point of view, the cost of memory may limit the amount of memory that may be included in the computer system. Increasing the amount of memory beyond some point might increase the cost significantly with minimal improvement in performance of the computer system.

Thus, in practice, computer systems might not have sufficient memory to store all applications and all relevant data. In that case, the persistent storage device (and/or some other large capacity, low cost, and possibly low performance memory device) may be used as a sort of extended memory. Pages may be copied from memory into the persistent storage device, so that they may be reloaded back into memory later. The page in memory may then be reused for other data. Computer systems may use any desired algorithms to determine what pages should be moved to persistent storage. For example, computers might use a Least Frequently Used (LFU) or Least Recently Used (LRU) algorithm to select the page(s) that have been used the least frequently or least recently, respectively, to transfer those pages to persistent storage.

But swapping pages to a persistent storage device may add some time to processing requests. For example, if an application requests some data that has been swapped to the persistent storage device, the data might be reloaded back into a page of memory before the request for the data is satisfied and the data is returned. Since accessing the persistent storage may be slower than accessing the memory, the time required to load the page back into the memory from the persistent storage may introduce some additional latency. For applications that are time-sensitive, this additional delay may be problematic.

Embodiments of the disclosure address these problems by using a cache-coherent interconnect memory module (CMM) as a swap space. In some embodiments of the disclosure, the CMM may be a Compute Express Link® (CXL®) memory module. (Compute Express Link and CXL are registered trademarks of the Compute Express Link Consortium in the United States.) A CMM may include a storage device, such as a NAND flash Solid State Drive (SSD) and some memory, such as a Dynamic Random Access Memory (DRAM). Data written to the CMM as part of a page swap may be stored in the memory of the CMM and later written to the storage device. If the page remains in the memory of the CMM, the page may be returned to the memory of the computer system more rapidly than reading the page from the storage device.

In some embodiments of the disclosure, the CMM may be exposed to the computer system as a disk, and the computer system may then use the CMM as a swap space. In other embodiments of the disclosure, the CMM may be exposed to the computer system as an extension of memory (remote memory or Non-Uniform Memory Access (NUMA) memory), but may be used by the computer system as a swap space, in which case the CMM may not be visible to applications running on the computer system. In still other embodiments of the disclosure, the CMM may be partly exposed to applications running on the computer system and partly reserved as a swap space.

By accessing data from the memory of the CMM, it may be possible to swap pages at a smaller granularity than the CMM might otherwise offer if accessed as a storage device.

In some embodiments of the disclosure, the operating system of the computer may be modified to leverage benefits of the CMM. For example, the page table, which may track which data is currently in the memory of the computer system vs. stored in the swap space, may be stored on the CMM rather than in the memory of the computer system, thereby freeing up additional memory in the computer system for application data. Or, the operating system may offload to the CMM various operations normally performed in swapping pages in and out of the memory of the computer system, including the selection of which pages to swap, compression/decompression of data before storage in the CMM, or the actual movement of pages in and/or out of the memory of the computer system. Or, the operating system may instruct the CMM to preload data from the storage device into the memory of the CMM, so that the data may be moved more quickly into the memory of the computer system when requested by the application.

An advantage of using the CMM is that by storing data in the memory of the CMM, access to the storage device may be reduced. As storage devices such as NAND flash SSDs experience wear when data is written to and erased from the storage device, reducing the amount of access to the NAND flash SSD may extend the life of the storage device.

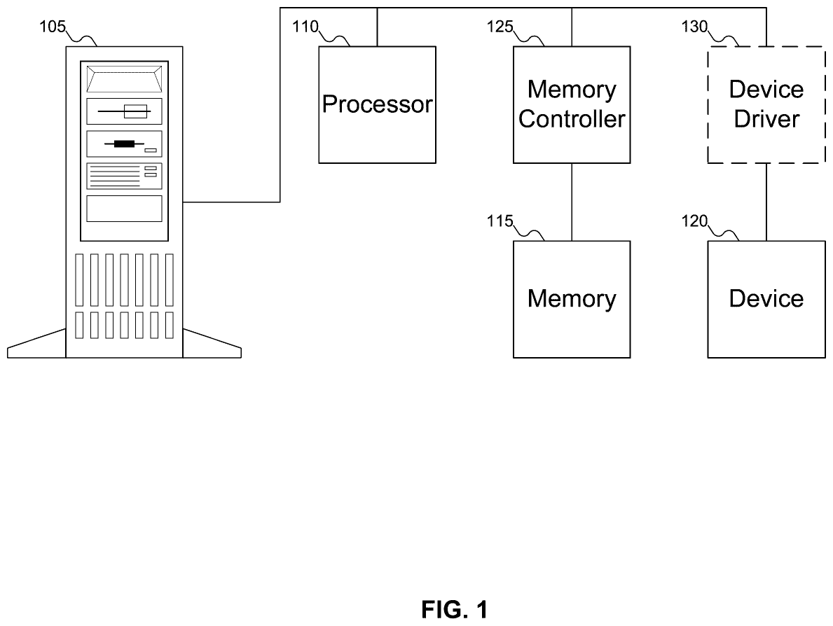

FIG. 1 shows a machine including a device to act as a swap space, according to embodiments of the disclosure. In FIG. 1, machine 105, which may also be termed a host or a system, may include processor 110, memory 115, and device 120. Machine 105 may also include other elements not shown: for example, storage devices. Processor 110, memory 115, and device 120, along with the other components discussed below, are shown outside the machine for ease of illustration: embodiments of the disclosure may include these components within machine 105.

Processor 110, which may also be referred to as a host processor, may be any variety of processor. While FIG. 1 shows a single processor 110, machine 105 may include any number (one or more, without bound) of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115, which may also be referred to as a main memory, may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage devices 120. Whereas memory 115 may be used to store data that is considered “short-term”, storage devices may be used to store data that is considered “long-term”: that is, data that is expected to be retained for longer periods of time and that should be retained in a persistent manner, even if deliver of power to machine 105 should be interrupted. Storage devices may be accessed using a device driver, such as device driver 130. In embodiments of the disclosure where machine 105 includes multiple storage devices, each storage device may be accessed by separate device drivers, a single device driver may support access to all storage devices, or any desired combination thereof.

Storage devices may be associated with an accelerator. Such an accelerator may be used for, for example, near-data processing. That is, the accelerator may be used to process data closer to storage devices, to reduce or eliminate transfer of data from storage devices into memory 115. The use of an accelerator for near-data processing may also offload processing from processor 110, as the accelerator may perform such processing instead of processor 110. Like processor 110, such an accelerator may implement a Reduced Instruction Set Computer (RISC) architecture or a Complex Instruction Set Computer (CISC) architecture (among other possibilities), and may be implemented using a Central Processing Unit (CPU), a Field Programmable Gate Array (FPGA), an Application-Specific Integrated Circuit (ASIC), A System-on-a-Chip (SoC), a Graphics Processing Unit (GPU), a General Purpose GPU (GPGPU), a Neural Processing Unit (NPU), or a Tensor Processing Unit (TPU).

The combination of storage devices and accelerator may also be referred to as a computational storage device, computational storage unit, computational storage device, or computational device. Storage devices and an accelerator may be designed and manufactured as a single integrated unit, or the accelerator may be separate from storage devices. The phrase “associated with” is intended to cover both a single integrated unit including both a storage device and an accelerator and a storage device that is paired with an accelerator but that are not manufactured as a single integrated unit. In other words, a storage device and an accelerator may be said to be “paired” when they are physically separate devices but are connected in a manner that enables them to communicate with each other. Further, in the remainder of this document, any reference to storage devices may be understood to refer to both storage devices and the accelerator either as physically separate but paired (and therefore may include the other device) or to both devices integrated into a single component as a computational storage unit.

In addition, the connection between storage devices and paired accelerators might enable the two devices to communicate, but might not enable one (or both) devices to work with a different partner: that is, a storage device might not be able to communicate with another accelerator, and/or the accelerator might not be able to communicate with another storage device. For example, a storage device and the paired accelerator might be connected serially (in either order) to the fabric, enabling the accelerator to access information from the storage device in a manner another accelerator might not be able to achieve.

While FIG. 1 uses the generic term “storage device”, embodiments of the disclosure may include any storage device formats that may be associated with computational storage, examples of which may include hard disk drives and Solid State Drives (SSDs). In addition, storage devices may be of the same or different types. For example, one storage device might be an SSD, whereas another storage device might be a hard disk drive. Any reference to a specific type of storage device, such as an “SSD”, below should be understood to include such other embodiments of the disclosure.

Processor 110 and storage devices may communicate across a fabric (not shown in FIG. 1). This fabric may be any fabric along which information may be passed. Such fabrics may include fabrics that may be internal to machine 105, and which may use interfaces such as Peripheral Component Interconnect Express (PCIe), Serial AT Attachment (SATA), or Small Computer Systems Interface (SCSI), among others. Such fabrics may also include fabrics that may be external to machine 105, and which may use interfaces such as Ethernet, Infiniband, or Fibre Channel, among others. In addition, such fabrics may support one or more protocols, such as Non-Volatile Memory Express (NVMe), NVMe over Fabrics (NVMe-oF), Simple Service Discovery Protocol (SSDP), or a cache-coherent interconnect protocol, such as the Compute Express Link® (CXL®) protocol, among others. (Compute Express Link and CXL are registered trademarks of the Compute Express Link Consortium in the United States.) Thus, such fabrics may be thought of as encompassing both internal and external networking connections, over which commands may be sent, either directly or indirectly, to the storage devices. In embodiments of the disclosure where such fabrics support external networking connections, storage devices might be located externally to machine 105, and storage devices might receive requests from a processor remote from machine 105.

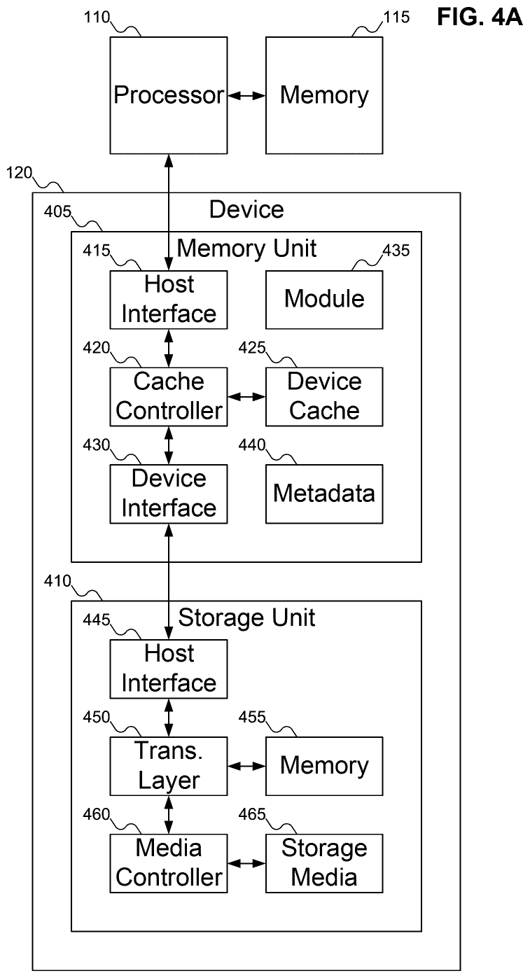

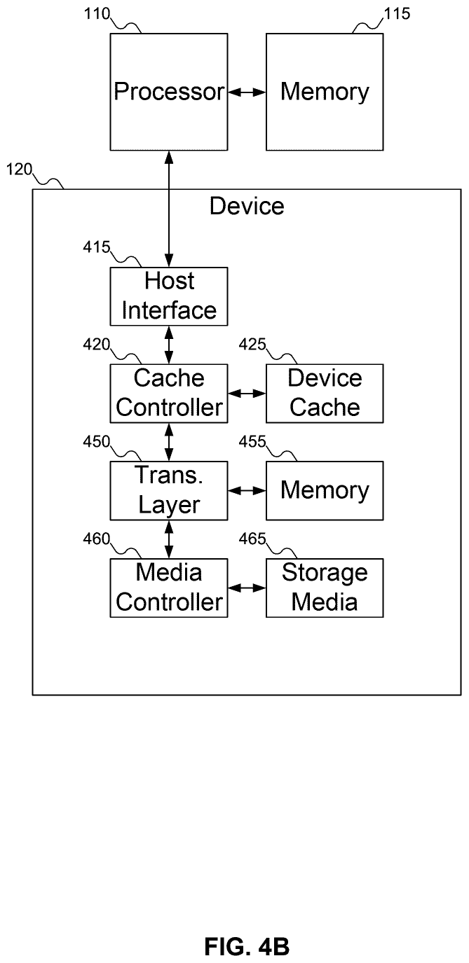

An example of a particular type of storage device may be device 120. As discussed with reference to FIGS. 4A-4B below, device 120 may be a tiered storage device, including both its own memory (such as DRAM or SRAM) and a persistent storage (such as an SSD). Device 120 may be used for a special purpose that may differ from the use of conventional storage devices, as discussed below. Device 120 may be supported by device driver 130, which may be used to access device 120. But in some embodiments of the disclosure, device driver 130 may be omitted (explaining why device driver 130 is shown with dashed lines).

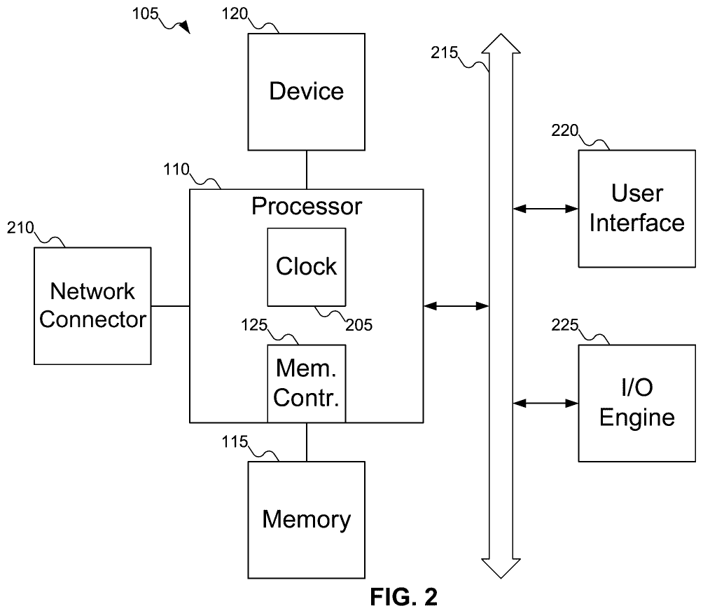

FIG. 2 shows details of the machine of FIG. 1, according to embodiments of the disclosure. In FIG. 2, typically, machine 105 includes one or more processors 110, which may include memory controllers 125 and clocks 205, which may be used to coordinate the operations of the components of machine 105. Processors 110 may also be coupled to memories 115, which may include random access memory (RAM), read-only memory (ROM), or other state preserving media, as examples. Processors 110 may also be coupled to devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

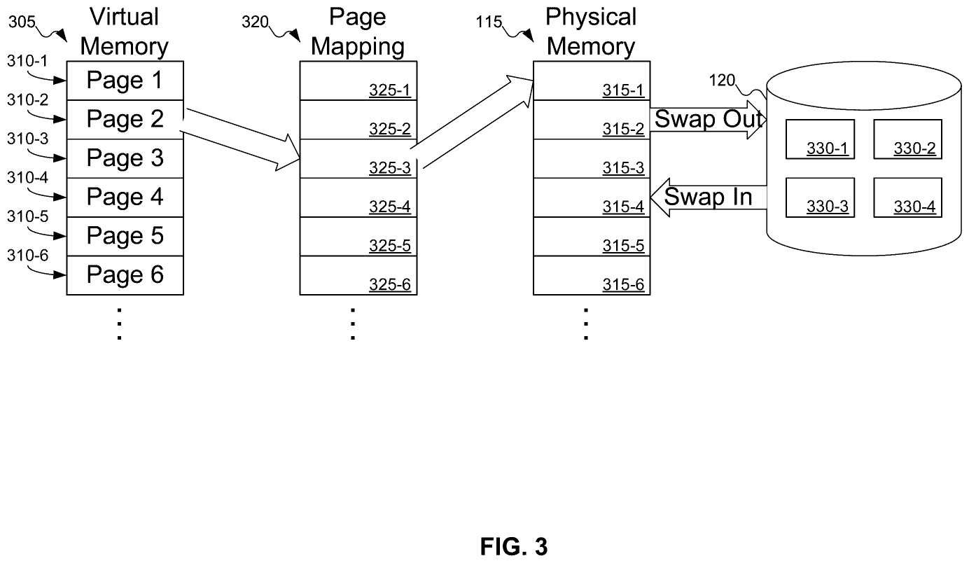

FIG. 3 shows how pages in memory 115 of FIG. 1 may be managed, according to embodiments of the disclosure. In machine 105 of FIG. 1, data may be stored in various pages as virtual memory 305. For example, virtual memory 305 may include virtual pages 310-1 through 310-6 (which may be referred to collectively as virtual pages 310 or pages 310). These virtual pages 310 may be stored in memory 115 as physical pages 315-1 through 315-6 (which may be referred to collectively as physical pages 315 or pages 315). The number of virtual pages 310 may vary depending on the needs of machine 105 of FIG. 1: as applications are executed and terminated, more or fewer virtual pages 310 may be needed.

In an ideal world, machine 105 of FIG. 1 would include sufficient memory 115 so that there are enough physical pages 315 to store all of virtual pages 310. Memory 115 tends to be a relatively fast access medium: the average time to access data from DRAM is between 50 and 150 nanoseconds (ns), as compared with 42-86 microseconds (μs) for NAND flash media or 9-12 milliseconds (ms) for hard disk drive platters. But DRAM also tends to be relatively more expensive than other storage media: the average cost per gigabyte (GB) for DRAM varies between $1.44 and $5.68, depending on the format used, whereas SSDs cost between $0.08 and $01.10 per GB, and hard disk drives cost between $0.03 and $0.06 per GB. Thus, to equip machine 105 of FIG. 1 with sufficient memory to store all pages 310 in virtual memory 305 might raise the cost significantly. Further, the entirety of that amount of DRAM would be used only occasionally, rendering the cost benefit of installing that much DRAM in machine 105 of FIG. 1 relatively inefficient.

Thus, a compromise is often used. Machine 105 is installed with some amount of memory 115, and a storage device, such as storage device 120, may be used as a swap space. As physical pages 315 in memory 115 are filled, the contents of some physical pages may be moved to the storage device, freeing up physical pages 315 for additional virtual pages 310. Then, when the contents of virtual pages 310 that were moved to the storage device are needed again, they may be brought back to physical pages 315 in memory 115. Machine 105 of FIG. 1—more specifically, the operating system running on processor 110 of FIG. 1—may include algorithms to select which physical pages 315 to transfer their contents to the storage device: for example, the contents of the least recently used (LRU) or the least frequently used (LFU) pages may be moved to the storage device. (Which pages' contents should be brought back into memory 115 may be determined either by the need for that data, or by the prediction that that data will be needed soon.)

To keep track of where the data is stored—any particular data might be currently stored in either memory 115 or the storage device, and might be stored at any particular address in either memory 115 or the storage device—the operating system may track where each virtual page 310 is stored using page table 320. Page table 320 may store a mapping indicating where each virtual page 310 is currently stored: whether in memory 115 or on the storage device, and at what address. Thus, by using the address provided by the application and page table 320, the operating system may determine where the data requested is actually stored at the moment so that the data may be accessed. And as data is moved around between (or within) memory 115 and the storage device, the operating system may update entries 325-1 through 325-6 (which may be referred to collectively as entries 325) in page table 320 to reflect the current location for the relevant data.

In FIG. 3, device 120 is shown as being used as a swap space. Device 120 may store pages 330-1 through 330-4 (which may be referred to collectively as pages 330). Pages 330 may store data referenced by applications as virtual pages 310, but that was swapped out of memory 115 to device 120. As shown, pages 315 and 330 may be swapped between memory 115 and device 120 as needed.

FIG. 4A shows a first example configuration of device 120 of FIG. 1, according to embodiments of the disclosure. In FIG. 4A, processor 110 may be associated with memory 115. Processor 110 may also communicate with device 120 (for example, over a fabric as discussed with reference to FIG. 1 above). Device 120 may be divided into two portions: memory unit 405 and storage unit 410. Memory unit 405 may be thought of as managing the DRAM (or other memory) of device 120, and storage unit 410 may be thought of as managing the persistent storage (such as NAND flash media) of device 120. In embodiments of the disclosure like that shown in FIG. 4A, memory unit 405 and storage unit 410 may be separate elements within device 120 rather than integrated as a single unit. That is, memory unit 405 may be implemented as a separate element from storage unit 410, which enables the assembly of device 120 using various different combinations of memory unit 405 and storage unit 410 as per a customer's requirements.

Memory unit 405 may include host interface 415, cache controller 420, device cache 425, and device interface 430. Host interface 415 may be an interface for device 120 to communicate with processor 110. Note that host interface 415 may be a physical interface, a logical interface, or both. For example, host interface 415 might be the physical connection offered by memory unit 405 to connect with, for example, a PCIe port in machine 105. Or, host interface 415 might be a logical interface, such as an endpoint used to communicate with processor 110 (with such communication potentially crossing a physical interface).

Cache controller 420 may be a controller for device cache 425. Device cache 425, which may also be referred to as cache 425 or memory 425, may be any desired form of memory, such as volatile storage like DRAM or SRAM, but other forms of memory may be used, including non-volatile storage. Cache controller 420 may then control the loading and/or storing of data in device cache 425. If, for example, device cache 425 includes DRAM or SRAM, similar to how memory 115 may include DRAM or SRAM, cache controller 420 may function similarly to memory controller 125 of FIG. 1.

Finally, device interface 430 may be an interface to communicate with storage unit 410. For example, device interface 430 may include an NVMe interface logic to send NVMe commands to storage unit 410.

Memory unit 405 may also include module 435 and metadata 440. Module 435 may be a module that may support page management in memory 115. For example, module 435 might perform compression and/or decompression of data, so that the data may be stored more efficiently in device cache 425. Or, module 435 might perform encryption and/or decryption of data, so that the data may be stored more securely in device cache 425. Or, module 435 might be responsible for selecting which pages to move from memory 115 to device cache 425, or from device cache 425 to memory 115. Or, module 435 might be responsible for performing the transfer of data between memory 115 and device cache 425: for example, using a direct memory access (DMA) command. Module 435 may also perform other functions in support of page management in memory 115, as desired. Module 435 may perform any or all of these functions, thereby reducing the load on processor 110. In addition, memory unit 405 may include multiple modules 435, which may perform various functions.

Metadata 440 may store information relevant to page management in memory 115. For example, metadata 440 may store page table 320 of FIG. 3, thereby increasing the amount of memory 115 available for use by applications executing on processor 110. Metadata 440 may also store page tracking data, such as information used in determining what pages should be swapped out of memory 115 into device cache 425. For example, the page tracking data might include temperature data, indicating if the corresponding page 310 of FIG. 3 is hot (currently or recently used) or cold (not used in a while). Temperature data may have more gradations than just a binary split: for example, temperature data might range from 0-3, with 0 being the coldest temperature and 3 being the hottest temperature. Other ranges are also possible. Or, the page tracking data might include a count of how often the corresponding page 310 of FIG. 3 has been accessed, or the last time the corresponding page 310 of FIG. 3 was accessed.

Memory unit 405 may be implemented using any desired technology. For example, memory unit 405 may be implemented as a processor, like processor 110, a Field Programmable Gate Array (FPGA), an Application-Specific Integrated Circuit (ASIC), A System-on-a-Chip (SoC), a Graphics Processing Unit (GPU), a General Purpose GPU (GPGPU), a Neural Processing Unit (NPU), or a Tensor Processing Unit (TPU).

Storage unit 410 may include host interface 445, translation layer 450, memory 455, media controller 460, and storage media 465. Host interface 445 may be an interface used by storage unit 410 to communicate with memory unit 405 (or with processor 110, if storage unit 410 was a storage device used to store data for applications executing on processor 110). Like host interface 415, host interface 445 may be a physical interface, a logical interface, or both. For example, host interface 445 might be the physical connection offered by storage unit 410 to connect with, for example, device interface 430 (or with a PCIe port in machine 105). Or, host interface 445 might be a logical interface, such as an endpoint used to communicate with device interface 430 (or processor 110) (with such communication potentially crossing a physical interface).

Translation layer 450 may manage the translation of an address as used by processor 110 to an address where the data is actually stored in storage media 465. For example, in NAND flash media, data typically may not be overwritten in place. Thus, when data is modified by processor 110, the new data may be stored in a different location in the NAND flash media. Rather than updating processor 110 every time the data is moved, translation layer 450 may manage the translation between a logical address as might be used by processor 110 and a physical address where the data may be stored in storage media 465. The translation table storing this mapping between logical and physical addresses may be stored in memory 455, which may be any desired form of memory. (If memory 455 is a volatile storage, then the translation table may also be stored in the storage media as a backup.)

Media controller 460 may manage the access of data in storage media 465, which may be where the data is actually stored.

FIG. 4B shows a second example configuration of device 120 of FIG. 1, according to embodiments of the disclosure. In FIG. 4B, rather than device 120 including memory unit 405 of FIG. 4A and storage unit 410 of FIG. 4A as separate elements, device 120 may include both memory and storage management as a single device. Device 120 may therefore include host interface 415, cache controller 420, device cache 425, translation layer 450, memory 455, media controller 460, and storage media 465. The operation of these elements may be the same as described with reference to FIG. 4A above. And while not shown in FIG. 4B, device 120 may also include module 435 and/or metadata 440, as described with reference to FIG. 4A above.

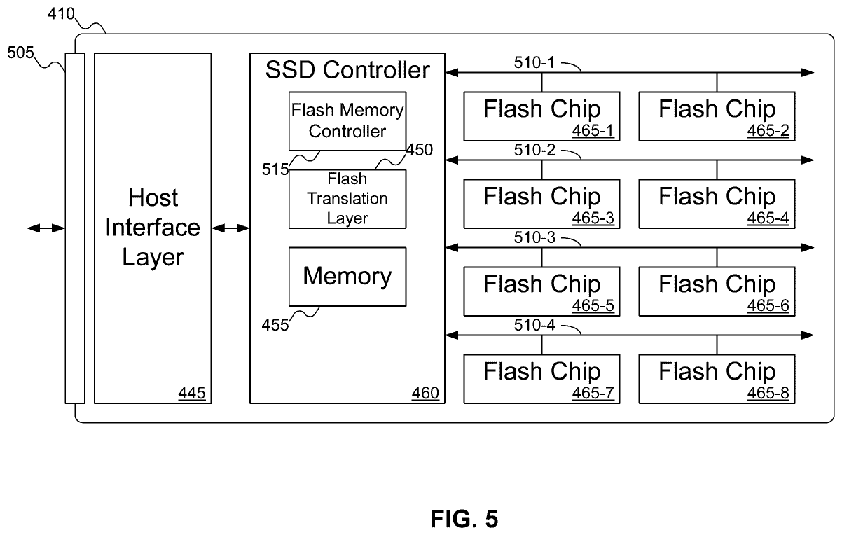

FIG. 5 shows details of storage unit 410 of FIG. 4A, according to embodiments of the disclosure (with the appropriate functionality also as reflected in device 120 of FIG. 4B as well). In FIG. 5, storage unit 410 is shown using an implementation including SSD 410, but embodiments of the disclosure are applicable to any type of storage device that may support caching of data, as discussed below.

SSD 410 may include interface 505 and host interface layer 445. Interface 505 may be an interface used to connect SSD 410 to machine 105 of FIG. 1. Examples of such interfaces may include Serial AT Attachment (SATA), mSATA, Serial Attached Small Computer Systems Interface (SCSI) (SAS), NVMe, PCIe, U.2, M.2, and Enterprise and Datacenter Standard Form Factor (EDSFF): other interfaces are also possible. SSD 410 may include more than one interface 505: for example, one interface might be used for block-based read and write requests, and another interface might be used for key-value read and write requests. While FIG. 5 suggests that interface 505 is a physical connection between SSD 410 and machine 105 of FIG. 1, interface 505 may also represent protocol differences that may be used across a common physical interface. For example, SSD 410 might be connected to machine 105 using a U.2, EDSFF, or an M.2 connector, among other possibilities, and SSD 410 may support block-based requests and key-value requests: handling the different types of requests may be performed by a different interface 505. SSD 410 may also include a single interface 505 that may include multiple ports, each of which may be treated as a separate interface 505, or just a single interface 505 with a single port, and leave the interpretation of the information received over interface 505 to another element, such as SSD controller 460.

Host interface layer 445 may manage interface 505, providing an interface between SSD controller 460 and the external connections to SSD 410. If SSD 410 includes more than one interface 505, a single host interface layer 445 may manage all interfaces, SSD 410 may include a host interface layer 445 for each interface, or some combination thereof may be used.

SSD 410 may also include SSD controller 460 and various flash memory chips 465-1 through 465-8, which may be organized along channels 510-1 through 510-4. Flash memory chips 465-1 through 465-8 may be referred to collectively as flash memory chips 465, and may also be referred to as flash chips, memory chips, storage media, NAND chips, chips, or dies. Channels 510-1 through 510-4 may be referred to collectively as channels 510.

SSD controller 460 may manage sending read requests and write requests to flash memory chips 465 along channels 510. Controller 460 may also include flash memory controller 515, which may be responsible for issuing commands to flash memory chips 465 along channels 510. Flash memory controller 515 may also be referred to more generally as memory controller 515 in embodiments of the disclosure where storage unit 410 stores data using a technology other than flash memory chips 465. Although FIG. 5 shows eight flash memory chips 465, four channels 510, and one flash memory controller 515, embodiments of the disclosure may include any number (one or more, without bound) of channels 510 including any number (one or more, without bound) of flash memory chips 465, and any number (one or more, without bound) of flash memory controllers 515.

Within each flash memory chip or die, the space may be organized into planes. These planes may include multiple erase blocks (which may also be referred to as blocks), which may be further subdivided into wordlines. The wordlines may include one or more pages. For example, a wordline for Triple Level Cell (TLC) flash media might include three pages, whereas a wordline for Multi-Level Cell (MLC) flash media might include two pages. In some embodiments of the disclosure, the page may be the smallest unit of data that may be written to or read from SSD 410; in other embodiments of the disclosure, the smallest unit of data that may be written to or read from SSD 410 may differ from the size of a page. A page may be, for example, 2 kilobytes (KB), 4 KB, or 8 KB, among other possibilities, and a block might have, for example, 128 pages, for a total block size of 512 KB.

Erase blocks may also be logically grouped together by controller 460, which may be referred to as a superblock. This logical grouping may enable controller 460 to manage the group as one, rather than managing each block separately. For example, a superblock might include one or more erase blocks from each plane from each die in storage unit 410. So, for example, if storage unit 410 includes eight channels, two dies per channel, and four planes per die, a superblock might include 8×2×4=64 erase blocks.

SSD controller 460 may also include flash translation layer (FTL) 450 (which may be termed more generally a translation layer, for storage devices that do not use flash storage). FTL 450 may handle translation of logical block addresses (LBAs) or other logical IDs (as used by processor 110 of FIG. 1) and physical block addresses (PBAs) or other physical addresses where data is stored in flash chips 465. FTL 450, may also be responsible for tracking data as it is relocated from one PBA to another, as may occur when performing garbage collection and/or wear leveling.

SSD controller 460 may also include memory 455, which flash translation layer 450 may use to store the translation table.

While FIG. 5 shows SSD controller 460 as including flash memory controller 515, flash translation layer 450, and memory 455, embodiments of the disclosure may have any, some, or all of these elements located outside SSD controller 460, without loss of generality.

As mentioned above, SSD 410 may read or write data in units of pages, but SSD 410 might not support updating data in place. That is, once data is written to an SSD, that data may not be changed where it is stored. Instead, to update the data, the update may be written to a new page/block on SSD 410, and the original data may be invalidated. As discussed with reference to FIG. 4A above, to support the possibility of data being updated and being written to different pages/blocks, SSD 410 may include flash translation layer 450, which may map an address received from processor 110 of FIG. 1 (or an application running on processor 110 of FIG. 1) to the physical address on SSD 410 where the data is actually stored. In this manner, processor 110 of FIG. 1 does not need to know the physical address where the data is stored, even if the data is moved during an update.

In addition, invalidating a page in a block in an SSD does not mean that new data may be written to the page. Before data may be written to a page, the page may need to be erased. But erasure may happen in units of blocks rather than pages. That is, SSD 410 might not support erasing just a single page: the entire block that includes that page may need to be erased.

Since erasure may happen in units of blocks, the ideal situation is that every page in the block has been invalidated (or was not written to in the first place): that is, that the block does not contain any valid data. But sometimes SSD 410 may need to erase a block even though the block contains some valid data. To erase that block, SSD 410 may program the valid data remaining in the block into page(s) in another block. Once all valid data has been programmed to another block, the block may be erased and new data may be written to the block. This process of moving any valid data in a block selected to be erased to a new block so that the block may then be erased may be termed garbage collection.

An SSD may also perform wear leveling. Each block in an SSD may be expected to support a predetermined number of program/erase cycles before the block is not guaranteed to successfully read or write data. In an attempt to keep the blocks in SSD 410 as balanced as possible in terms of the number of program/erase cycles, an SSD may perform wear levelling, which may bias SSD 410 toward writing data into blocks with lower program/erase cycle counts than blocks with higher program/erase cycle counts, and might even program data from a block in support of wear leveling (for example, moving data that has been stored in a block for a long time with a low program/erase cycle count so that the block might be used more, or moving data that is stored in a block with a high program/erase cycle count into another block so that the block with the high program/erase cycle count might be rotated “out of use” for a while).

As a result, garbage collection and/or wear leveling may require a valid block somewhere on SSD 410 to program valid data before a block may be erased. These facts provide an additional reason why SSD 410 may include flash translation layer 450, as there may be reasons other than data update that might result in data being moved to a new physical address.

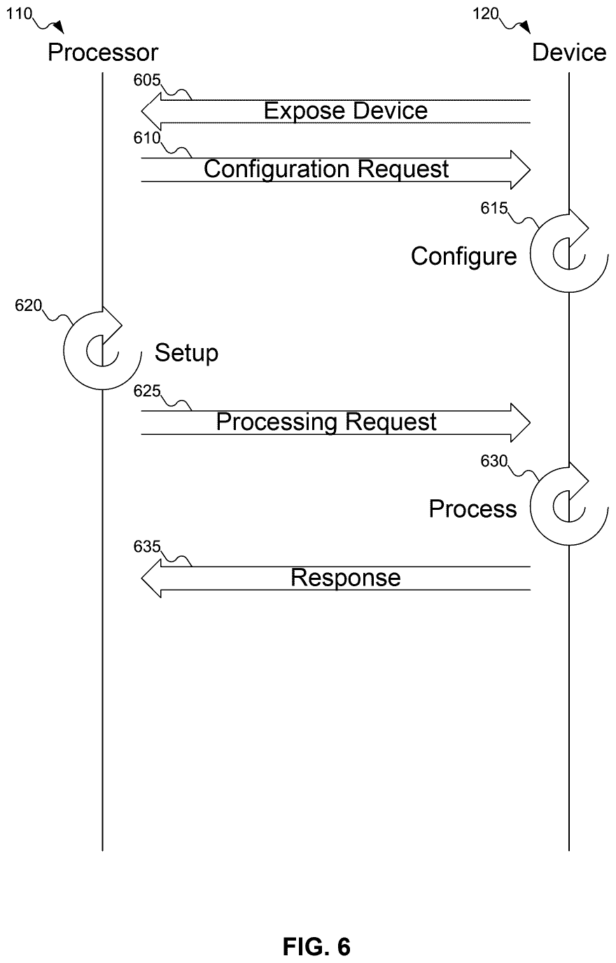

FIG. 6 shows messages being exchanged between processor 110 of FIG. 1 and device 120 of FIG. 1, according to embodiments of the disclosure. In FIG. 6, device 120 may expose itself to processor 110, shown as operation 605. In exposing itself, device 120 may inform processor 110 that device 120 exists and what its capabilities are. In response, processor 110 may send configuration request 610, requesting that device 120 configure itself for use as a swap space. Configuration request 610 may specify that device 120 configure itself as a disk or as a memory extension, depending on the desired implementation. Then, at operation 615, device 120 may configure itself in accordance with configuration request 610. At operation 620, processor 110 may also set itself up to use device 120 as a swap space. For example, processor 110 may hide the presence of device 120 from applications executing on processor 110, so that device 120 is reserved for use as a swap space.

Eventually, processor 110 may issue processing request 625. Processing request 625 might be a request to read data from device 120 to bring into memory 115 of FIG. 1, or to write data from memory 115 of FIG. 1 to device 120. But processing request 625 might involve other operations as well. For example, processing request 625 might request that device 120 take over management of page table 320 of FIG. 3. Or, processing request 625 might request that device 120 be responsible for selecting what pages to swap between memory 115 of FIG. 1 and device 120. Or, processing request 625 might request that device 120 update metadata 440 of FIG. 4A (such as page tracking data or page temperature data). Or, processing request 625 might request that device 120 preload some data from storage media 465 of FIGS. 4A-4B into device cache 425 of FIGS. 4A-4B. For example, processing request 625 may include a hint about what data might be needed soon, so that device 120 may preload the appropriate data from storage media 465 of FIGS. 4A-4B into device cache 425 of FIGS. 4A-4B.

Regardless of what processing request 625 requests, device 120 may process processing request 625 as operation 630, and may return a result as response 635. Response 635 may vary according to processing request 625. For example, if processing request 625 is a request to read data from device 120, then response 635 may return the data. Or, if processing request 625 is a request to write data from device 120, then response 635 may indicate that the write was successfully completed. Or, if processing request 625 is a request for device 120 to manage page table 320 of FIG. 3, then response 635 may be a completion message. Or, if processing request 625 is a request that device 120 be responsible for swapping pages between memory 115 of FIG. 1 and device 120, then response 635 may be a message indicating that one or more pages are being swapped between memory 115 of FIG. 1 and device 120. Or, if processing request 625 is a request to update metadata 440 of FIG. 4A, then response 635 may indicate that metadata 440 of FIG. 4A has been updated. Or, if processing request 625 is a request to preload data from storage media 465 of FIGS. 4A-4B into device cache 425 of FIGS. 4A-4B, device 120 may load the data in question from storage media 465 of FIGS. 4A-4B into device cache 425 of FIGS. 4A-4B.

In some embodiments of the disclosure, device 120 may be used as a RAM disk. That is, device 120 may function as it was a block device, used for reading and writing like a storage device, even though a portion (or all) of device cache 425 of FIGS. 4A-4B is being used as though it was a block device. For example, if device 120 uses the CXL protocols, device 120 may receive requests from processor 110 as CXL.io requests. In such embodiments of the disclosure, device 120 may be supported by device driver 130 of FIG. 1. In addition, because device 120 is being used as a swap space for memory 115 of FIG. 1, the operating system running on machine 105 of FIG. 1 may “hide” device 120 from applications executing on processor 110. That is, device 120 might be used only as a swap space, and not otherwise accessible as a storage device.

In other embodiments of the disclosure, device 120 may operate as an extension of memory 115 of FIG. 1. That is, device 120 may advertise itself as though it was memory, and may be assigned an address range just like memory 115 of FIG. 1. For example, if device 120 uses the CXL protocols, device 120 may receive requests from processor 110 as CXL.mem requests. But as device 120 is still being used as a swap space, the address range assigned to device 120 may be reserved for use by the operating system, so that applications executing on processor 110 do not attempt to load or store data from addresses assigned to device 120.

Each of these approaches has relative benefits. Using device 120 as a block device (such as a RAM disk) permits device 120 to be used with its speed benefits (device cache 425 of FIGS. 4A-4B being relatively faster to access than storage media 465 of FIGS. 4A-4B), without any changes to the operating system (the disk appears to be just a storage device and may be written and read like any storage device). But because device 120 functions as a storage device, device 120 would expect data to be transferred in units of pages or blocks, which may include a lot of data. It may be possible to support accessing requests from device 120 that are smaller than the page or block size, but the operating system may require some modifications to support using device 120, configured as a block device, as a swap space with a smaller access size than the page or block.

On the other hand, using device 120 as an extension of memory 115 of FIG. 1 may enable access of data from device cache 425 of FIGS. 4A-4B in smaller units: for example, a 64 byte (B) cache line. Transferring data from storage media 465 of FIGS. 4A-4B to device cache 425 of FIGS. 4A-4B might still involve accessing a full page or block from storage media 465 of FIGS. 4A-4B and transferring that full page or block into device cache 425 of FIGS. 4A-4B, but only a single cache line might be transferred to memory 115 of FIG. 1. The rest of the page or block may be swapped later into memory 115 of FIG. 1, without unduly delaying the software that requested the particular cache line.

In either situation, module 435 of FIG. 4A may be used to support page management operations, including letting device 120 perform compression/decompression, encryption/decryption, tracking of page temperature, selection of pages to swap between memory 115 of FIG. 1 and device 120, data transfer between memory 115 of FIG. 1 and device 120, and/or other page management operation. This approach may enable additional optimizations to be possible.

One situation that has not yet been discussed is where there is a page fault: that is, where processor 110 attempts to access data from a page in memory 115 of FIG. 1, but that data is not currently in memory 115 of FIG. 1. In that situation, memory 115 may transfer the requested data from device 120 to memory 115 of FIG. 1. As discussed with reference to FIG. 4A above, a DMA may be used to transfer the data from device 120 to memory 115 of FIG. 1. In some embodiments of the disclosure, processor 110 may perform this DMA itself; in other embodiments of the disclosure, processor 110 may request that device 120 perform this DMA operation. Note that in some situations, the data in question might not be device cache 425 of FIGS. 4A-4B, in which case device 120 may need to retrieve the data from storage media 465 of FIGS. 4A-4B before the data may be transferred to memory 115 of FIG. 1. Processor 110 might also use information about the data that triggered the page fault to request that device 120 preload some data from storage media 465 of FIGS. 4A-4B into device cache 425 of FIGS. 4A-4B.

In addition, some embodiments of the disclosure may use one portion of device 120 as either a disk or a memory extension for use as a swap space, and another portion of device 120 may be used as either a disk for application use or as a memory extension for application use. Thus, for example, consider device 120 offering a total of 2 terabytes (TB) of storage. 1 TB of the capacity of device 120 might be used as a swap space (either as a disk or as a memory extension) that is hidden from applications executing on processor 110, and the other 1 TB of the capacity of device 120 might be used either as a disk or a memory extension that is visible to applications executing on processor 110.

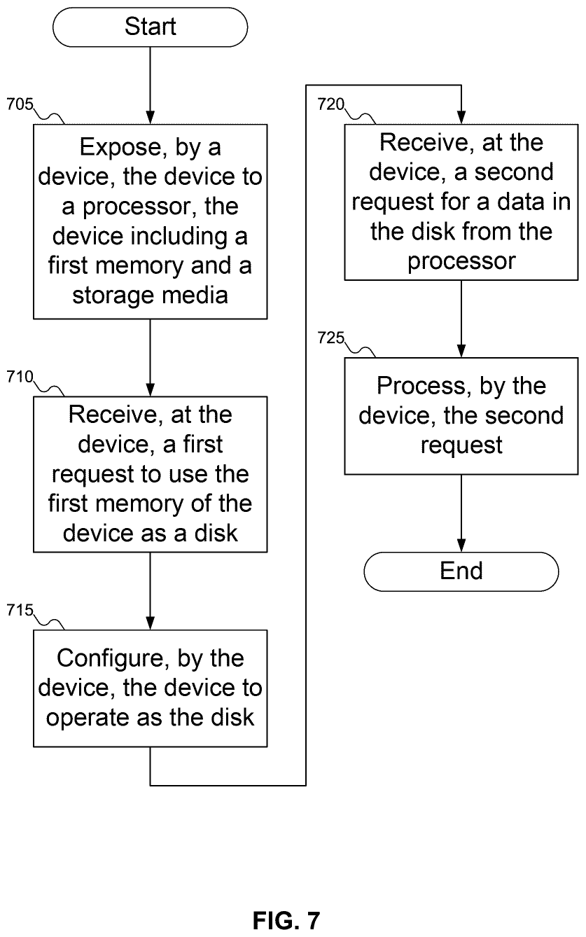

FIG. 7 shows a flowchart of an example procedure for device 120 of FIG. 1 to be used as a disk for use as swap space for memory 115 of FIG. 1, according to embodiments of the disclosure. In FIG. 7, at block 705, device 120 of FIG. 1 may expose to processor 110 of FIG. 1 that device 120 of FIG. 1 exists, and that device 120 of FIG. 1 includes device cache 425 of FIGS. 4A-4B and storage media 465 of FIGS. 4A-4B. At block 710, device 120 of FIG. 1 may receive from processor 110 of FIG. 1 configuration request 610 of FIG. 6 that device 120 of FIG. 1 configure itself as a disk. At block 715, device 120 of FIG. 1 may then configure itself as a disk, in accordance with the request from processor 110 of FIG. 1. At block 720, device 120 of FIG. 1 may receive from processor 110 of FIG. 1 processing request 625 of FIG. 6 for data in device 120 of FIG. 1. As device 120 of FIG. 1 may function as a disk, processing request 625 of FIG. 6 might include a read request to read data from device 120, or to write data to device 120 of FIG. 1. Finally, at block 725, device 120 of FIG. 1 may process processing request 625 and return result 635 of FIG. 6.

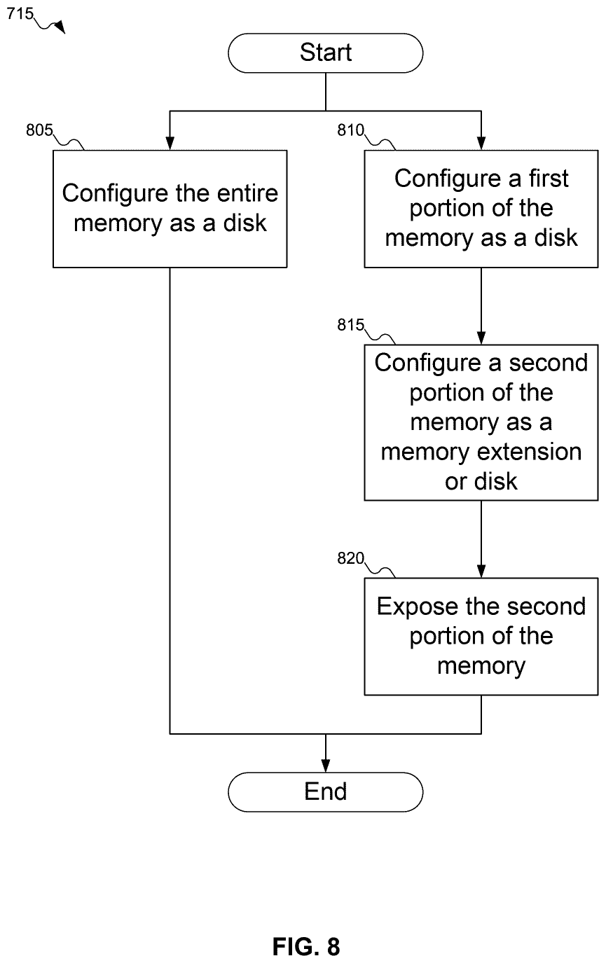

FIG. 8 shows a flowchart of an example procedure for device 120 of FIG. 1 to configure itself as a disk for use as a swap space for memory 115 of FIG. 1, according to embodiments of the disclosure. In FIG. 8, at block 805, device 120 of FIG. 1 may configure itself entirely as a disk for use by processor 110 of FIG. 1 as a swap space.

Alternatively, at block 810, device 120 of FIG. 1 may configured only a portion of itself as a disk for use as a swap space by processor 110 of FIG. 1. At block 815, device 120 of FIG. 1 may then configure the rest of device 120 of FIG. 1 as either a disk or as a memory extension, depending on the desired implementation. Note that there is no problem with dividing device 120 of FIG. 1 into two portions, each of which is configured separately as a disk: one portion is reserved for use as a swap space, and the other portion is accessible to applications to store data. Finally, at block 820, processor 110 of FIG. 1 may expose the second portion of device 120 of FIG. 1 for use by applications executing on processor 110 of FIG. 1 (with the portion of device 120 of FIG. 1 reserved for use as a swap space hidden by processor 110 of FIG. 1 so that applications may not access that portion of device 120 of FIG. 1).

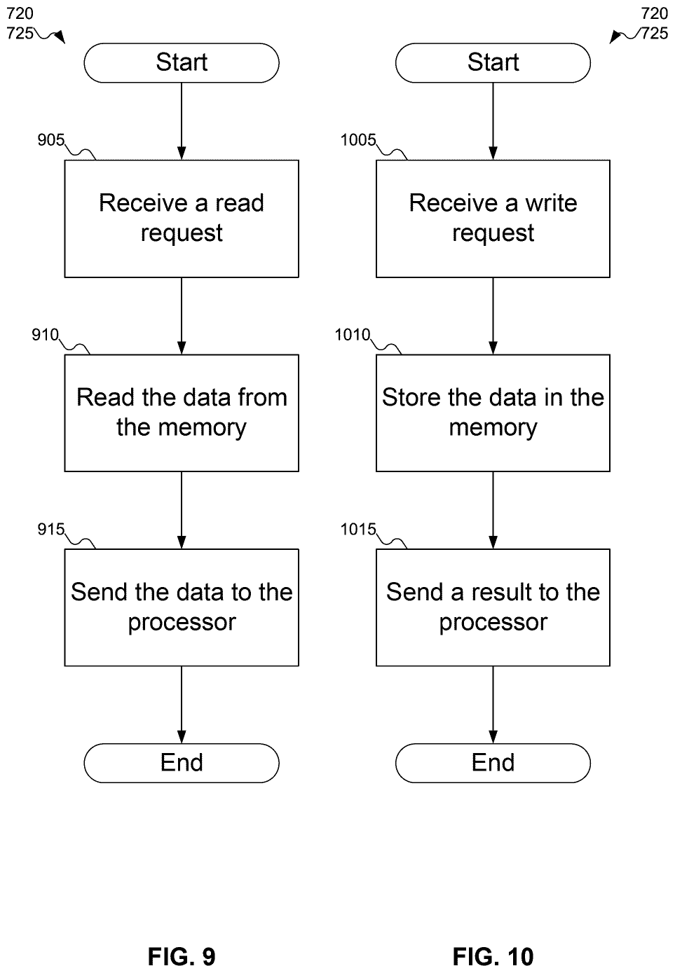

FIG. 9 shows a flowchart of an example procedure for device 120 of FIG. 1 to process a read request from processor 110 of FIG. 1, according to embodiments of the disclosure. In FIG. 9, at block 905, device 120 of FIG. 1 may receive processing request 625 of FIG. 6 as a read request. At block 910, device 120 of FIG. 1 may then read the data from device cache 425 of FIGS. 4A-4B, and at block 915, device 120 of FIG. 1 may send response 635 of FIG. 6 including the data to processor 110 of FIG. 1.

FIG. 10 shows a flowchart of an example procedure for device 120 of FIG. 1 to process a write request from processor 110 of FIG. 1, according to embodiments of the disclosure. In FIG. 10, at block 1005, device 120 of FIG. 1 may receive processing request 625 of FIG. 6 as a write request, which may include data to be written to device 120 of FIG. 1. At block 1010, device 120 of FIG. 1 may then write the data to device cache 425 of FIGS. 4A-4B, and at block 1015, device 120 of FIG. 1 may send response 635 of FIG. 6 indicating that the write request has completed processing to processor 110 of FIG. 1.

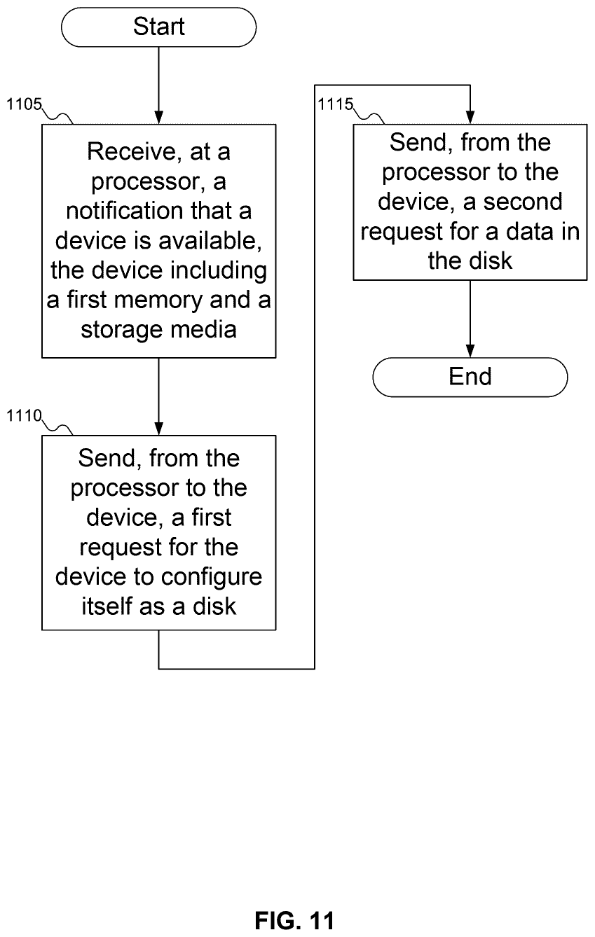

FIG. 11 shows a flowchart of an example procedure for processor 110 of FIG. 1 to request that device 120 of FIG. 1 be configured as a disk for use as a swap space for memory 115 of FIG. 1, according to embodiments of the disclosure. In FIG. 11, at block 1105, processor 110 of FIG. 1 may receive a notification that device 120 of FIG. 1 is available (that is, has been exposed to processor 110 of FIG. 1). At block 1110, processor 110 of FIG. 1 may send configuration request 610 of FIG. 6 to device 120 of FIG. 1, requesting that device 120 of FIG. 1 configure itself as a disk. Finally, at block 1115, processor 110 of FIG. 1 may send processing request 625 of FIG. 6 to device 120 of FIG. 1.

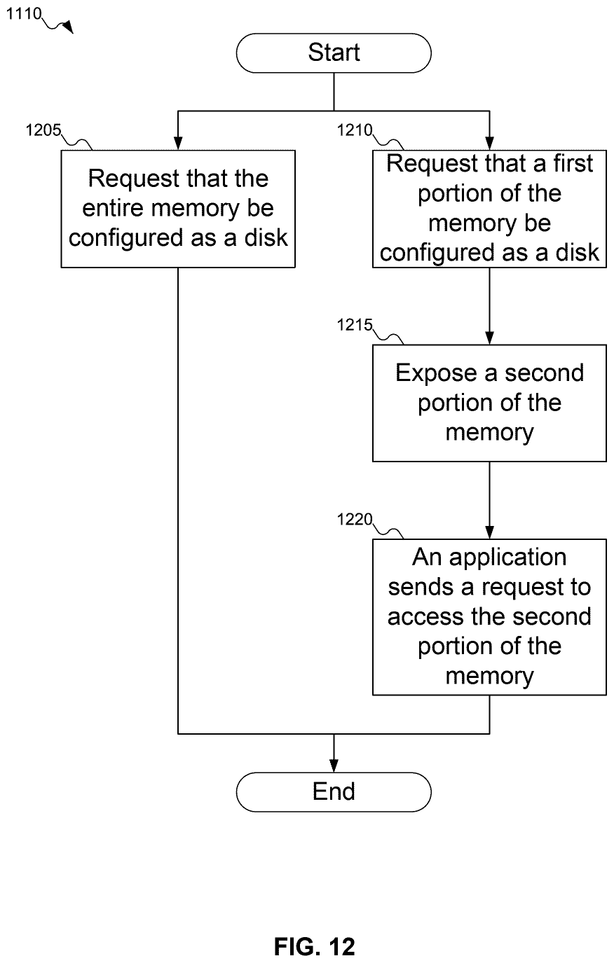

FIG. 12 shows a flowchart of an example procedure for processor 110 of FIG. 1 to request that device 120 of FIG. 1 configure itself as a disk for use as a swap space for memory 115 of FIG. 1, according to embodiments of the disclosure. In FIG. 12, at block 1205, processor 110 of FIG. 1 may request that device 120 of FIG. 1 configure itself entirely as a disk for use by processor 110 of FIG. 1.

Alternatively, at block 1210, processor 110 of FIG. 1 may request that device 120 of FIG. 1 configure only a portion of itself as a disk for use as a swap space by processor 110 of FIG. 1. At block 1215, processor 110 of FIG. 1 may then expose a second portion of device 120 of FIG. 1 to applications executing on processor 110 of FIG. 1 for their use (either as a memory extension or as a disk). Finally, at block 1220, an application executing on processor 110 of FIG. 1 may send a request to device 120 of FIG. 1 to access data stored on the second (exposed) portion of device 120 of FIG. 1.

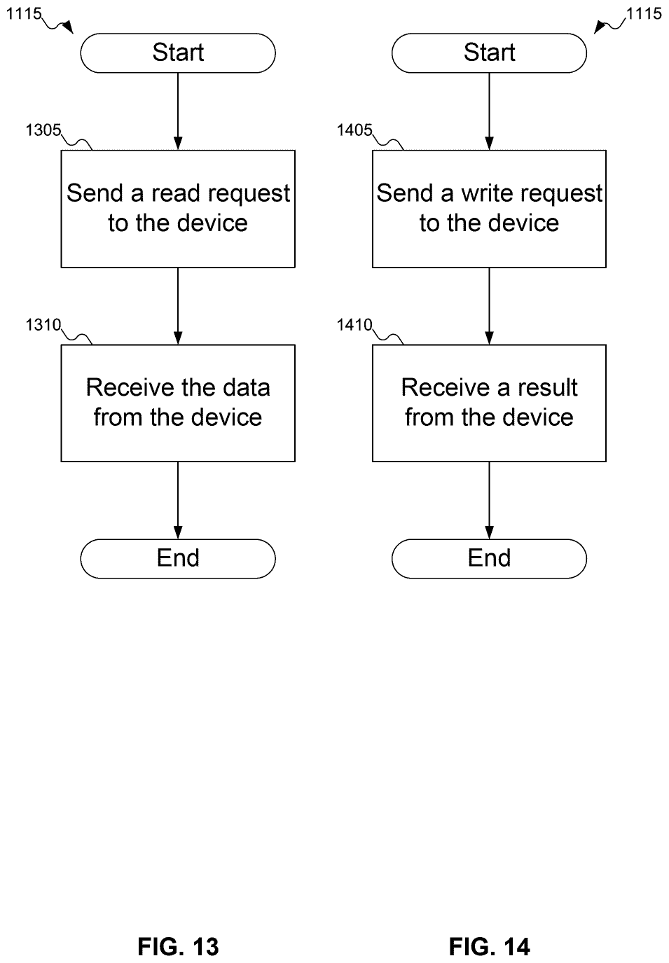

FIG. 13 shows a flowchart of an example procedure for processor 110 of FIG. 1 to issue a read request to device 120 of FIG. 1, according to embodiments of the disclosure. In FIG. 13, at block 1305, processor 1305 may send to device 120 of FIG. 1 processing request 625 of FIG. 6 as a read request. At block 1310, processor 110 of FIG. 1 may receive response 635 of FIG. 6 from device 120 of FIG. 1, which may including the requested data.

FIG. 14 shows a flowchart of an example procedure for processor 110 of FIG. 1 to issue a write request to device 120 of FIG. 1, according to embodiments of the disclosure. In FIG. 14, at block 1405, processor 110 of FIG. 1 may send to device 120 of FIG. 1 processing request 625 of FIG. 6 as a write request, which may include data to be written to device 120 of FIG. 1. At block 1410, processor 110 of FIG. 1 may receive response 635 of FIG. 6 from device 120 of FIG. 1, indicating that the data was successfully written to device 120 of FIG. 1.

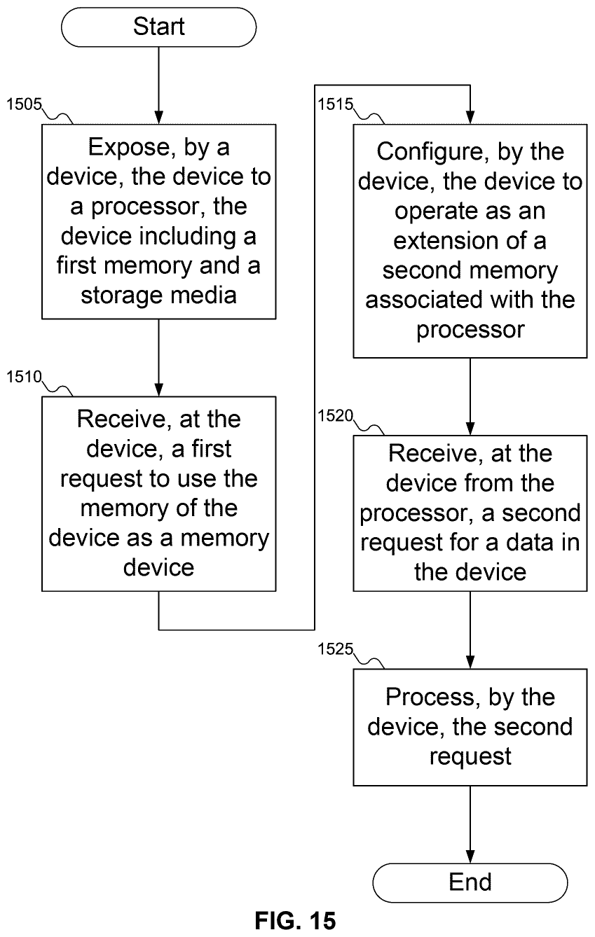

FIG. 15 shows a flowchart of an example procedure for device 120 of FIG. 1 to be used as a memory extension for use as swap space for memory 115 of FIG. 1, according to embodiments of the disclosure. In FIG. 15, at block 1505, device 120 of FIG. 1 may expose to processor 110 of FIG. 1 that device 120 of FIG. 1 exists, and that device 120 of FIG. 1 includes device cache 425 of FIGS. 4A-4B and storage media 465 of FIGS. 4A-4B. At block 1510, device 120 of FIG. 1 may receive from processor 110 of FIG. 1 configuration request 610 of FIG. 6 that device 120 of FIG. 1 configure itself as a memory extension. At block 1515, device 120 of FIG. 1 may then configure itself as a memory extension, in accordance with the request from processor 110 of FIG. 1. At block 1520, device 120 of FIG. 1 may receive from processor 110 of FIG. 1 processing request 625 of FIG. 6 for data in device 120 of FIG. 1. As device 120 of FIG. 1 may function as a disk, processing request 625 of FIG. 6 might include a read request to read data from device 120, or to write data to device 120 of FIG. 1. Finally, at block 1525, device 120 of FIG. 1 may process processing request 625 and return result 635 of FIG. 6.

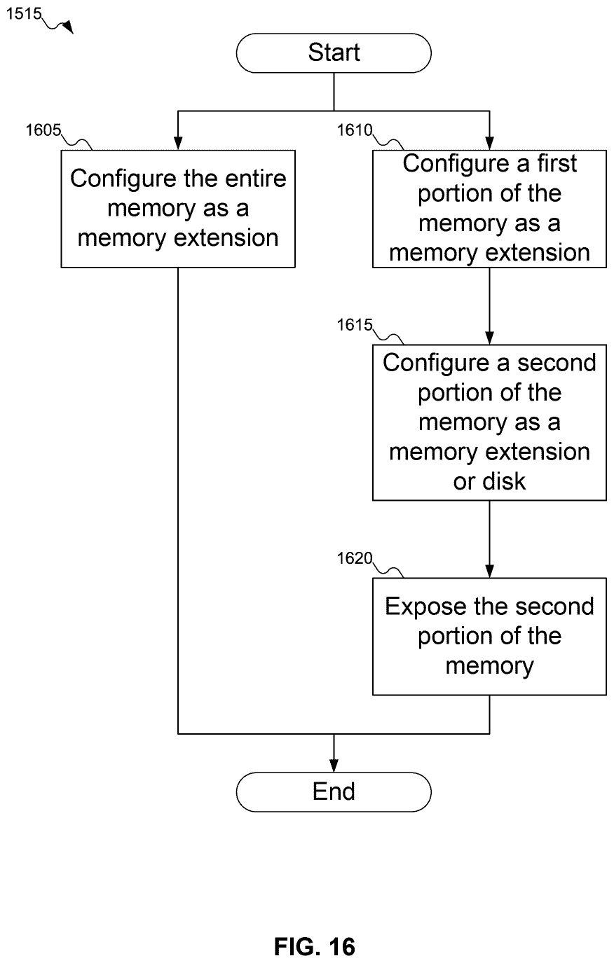

FIG. 16 shows a flowchart of an example procedure for device 120 of FIG. 1 to configure itself as a memory extension for use as a swap space for memory 115 of FIG. 1, according to embodiments of the disclosure. In FIG. 16, at block 1605, device 120 of FIG. 1 may configure itself entirely as a memory extension for use by processor 110 of FIG. 1 as a swap space.

Alternatively, at block 1610, device 120 of FIG. 1 may configured only a portion of itself as a memory extension for use as a swap space by processor 110 of FIG. 1. At block 1615, device 120 of FIG. 1 may then configure the rest of device 120 of FIG. 1 as either a disk or as a memory extension, depending on the desired implementation. Note that there is no problem with dividing device 120 of FIG. 1 into two portions, each of which is configured separately as a memory extension: one portion is reserved for use as a swap space, and the other portion is accessible to applications to store data. Finally, at block 1620, processor 110 of FIG. 1 may expose the second portion of device 120 of FIG. 1 for use by applications executing on processor 110 of FIG. 1 (with the portion of device 120 of FIG. 1 reserved for use as a swap space hidden by processor 110 of FIG. 1 so that applications may not access that portion of device 120 of FIG. 1).

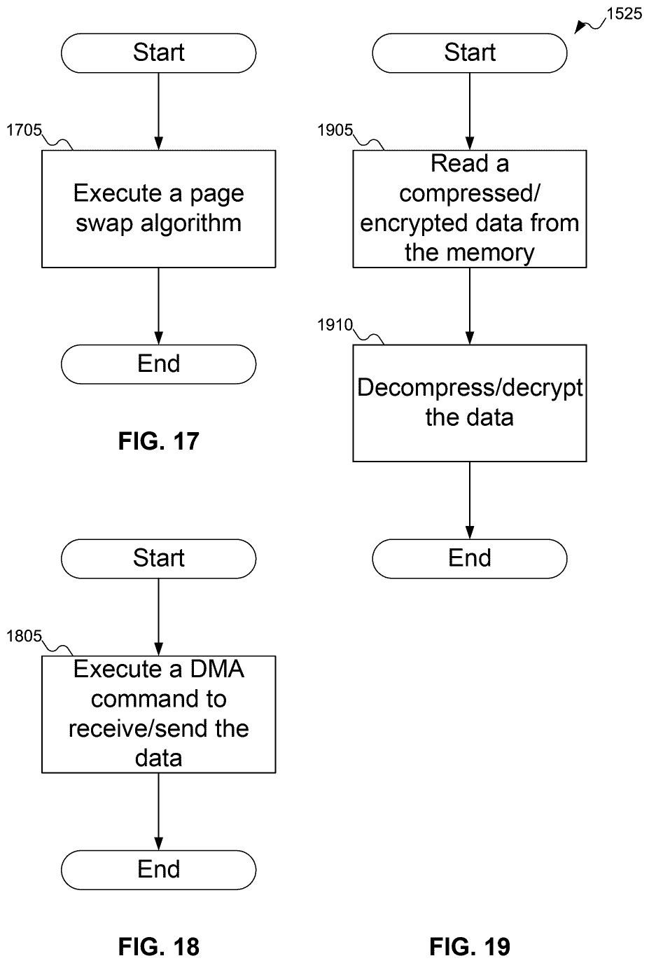

FIG. 17 shows a flowchart of an example procedure for device 120 of FIG. 1 to perform page swap management in memory 115 of FIG. 1, according to embodiments of the disclosure. In FIG. 17, at block 1705, in response to processing request 625 of FIG. 6 received from processor 110 of FIG. 1, device 120 of FIG. 1 may execute a page swap algorithm to select pages to swap between memory 115 and device 120 of FIG. 1. Any desired page swap algorithm may be used: for example, an LRU or an LFU algorithm may be used to select pages to swap in and out of memory 115 of FIG. 1.

FIG. 18 shows a flowchart of an example procedure for device 120 of FIG. 1 to perform a direct memory access to transfer data in or out of memory 115 of FIG. 1, according to embodiments of the disclosure. In FIG. 18, in response to processing request 625 of FIG. 6 received from processor 110 of FIG. 1, device 120 of FIG. 1 may issue a DMA request to transfer data between memory 115 and device 120 of FIG. 1. Note that by device 120 of FIG. 1 handing the data transfer, processor 110 of FIG. 1 may be relieved of that burden, which may reduce the load on processor 110 of FIG. 1.

FIG. 19 shows a flowchart of an example procedure for device 120 of FIG. 1 to perform decompression/decryption of data in response to a read request from processor 110 of FIG. 1, according to embodiments of the disclosure. In FIG. 19, at block 1905, device 120 of FIG. 1 may read data that is compressed or encrypted (or both). At block 1910, device 120 of FIG. 1 may decompress or decrypt (or both) the data, after which the decompressed/decrypted data may be sent to processor 110 of FIG. 1.

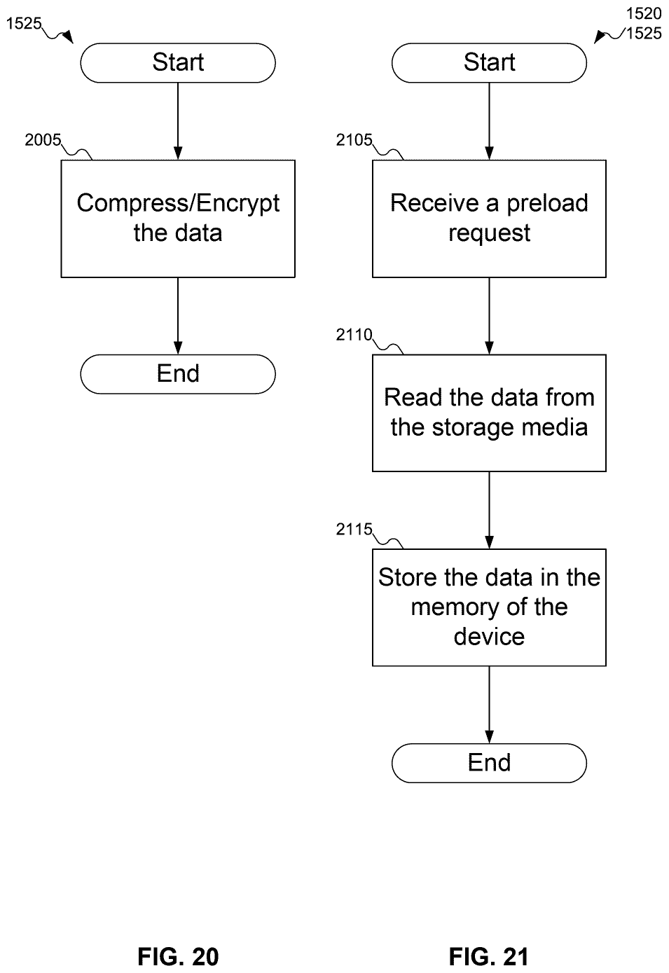

FIG. 20 shows a flowchart of an example procedure for device 120 of FIG. 1 to perform compression/encryption of data in response to a write request from processor 110 of FIG. 1, according to embodiments of the disclosure. In FIG. 20, at block 2005, device 120 of FIG. 1 may take the data received from processor 110 and may compress or encrypt (or both) the data for storage in device 120 of FIG. 1.

FIG. 21 shows a flowchart of an example procedure for device 120 of FIG. 1 to execute a preload request from processor 110 of FIG. 1, according to embodiments of the disclosure. At block 2105, device 120 of FIG. 1 may receive processing request 625 of FIG. 6 from processor 110 of FIG. 1 to preload data from storage media 465 of FIGS. 4A-4B into device cache 425 of FIGS. 4A-4B. At block 2110, device 120 of FIG. 1 may read the data from storage media 465 of FIGS. 4A-4B. Finally, at block 2115, device 120 of FIG. 1 may store the data in device cache 425 of FIGS. 4A-4B.

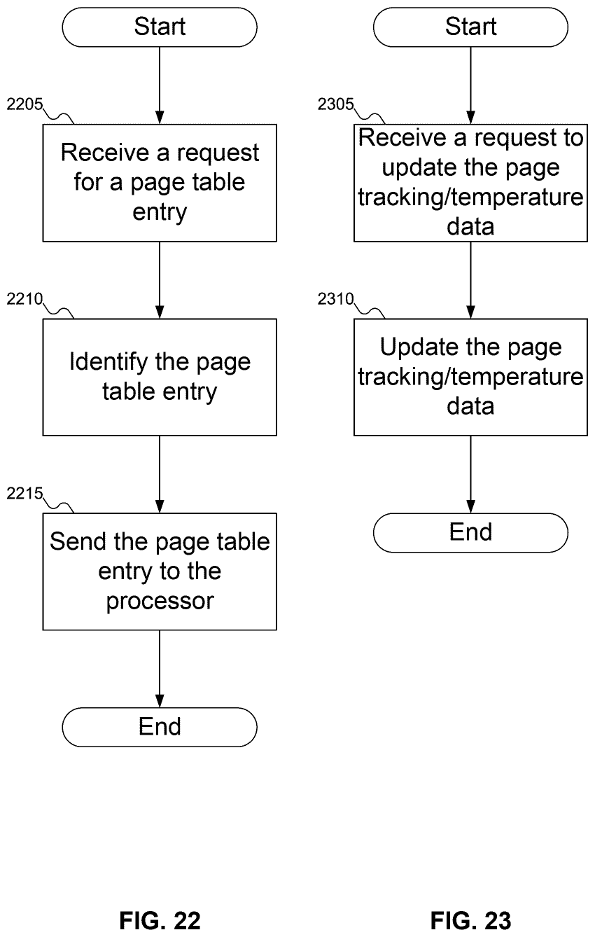

FIG. 22 shows a flowchart of an example procedure for device 120 of FIG. 1 to return an entry in page table 320 of FIG. 3 FIG. 3 in response to a request from processor 110 of FIG. 1, according to embodiments of the disclosure. In FIG. 22, at block 2205, device 120 of FIG. 1 may receive processing request 625 of FIG. 6 requesting entry 325 of FIG. 3 of page table 320 of FIG. 3. At block 2210, device 120 of FIG. 1 may identify entry 325 of FIG. 3 in page table 320 of FIG. 3 in metadata 440 of FIG. 4A. At block 2215, device 120 of FIG. 1 may send entry 325 of FIG. 3 in page table 320 of FIG. 3 to processor 110 of FIG. 1 as part of response 635 of FIG. 6.

FIG. 23 shows a flowchart of an example procedure for device 120 of FIG. 1 to update metadata 440 of FIG. 4A in response to a request from processor 110 of FIG. 1, according to embodiments of the disclosure. In FIG. 23, at block 2305, device 120 of FIG. 1 may receive processing request 625 of FIG. 6 requesting that metadata 440 of FIG. 4A be updated. As discussed with reference to FIG. 4A above, metadata 440 of FIG. 4A may be, for example, page tracking data or page temperature data. At block 2310, device 120 of FIG. 1 may update metadata 440 of FIG. 4A.

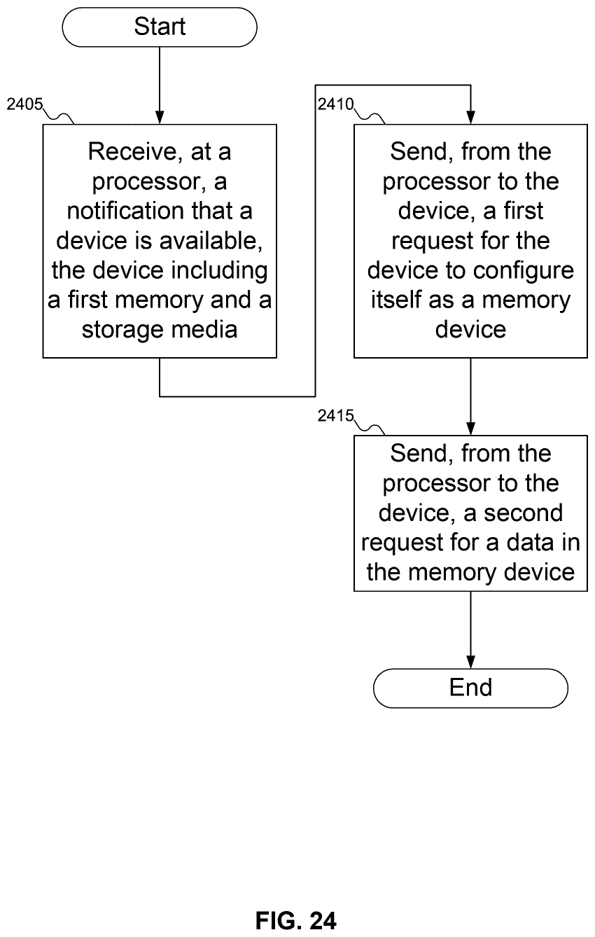

FIG. 24 shows a flowchart of an example procedure for processor 110 of FIG. 1 to request that device 120 of FIG. 1 be configured as a memory extension for use as a swap space for memory 115 of FIG. 1, according to embodiments of the disclosure. In FIG. 24, at block 2405, processor 110 of FIG. 1 may receive a notification that device 120 of FIG. 1 is available (that is, has been exposed to processor 110 of FIG. 1). At block 2410, processor 110 of FIG. 1 may send configuration request 610 of FIG. 6 to device 120 of FIG. 1, requesting that device 120 of FIG. 1 configure itself as a memory extension. Finally, at block 2415, processor 110 of FIG. 1 may send processing request 625 of FIG. 6 to device 120 of FIG. 1.

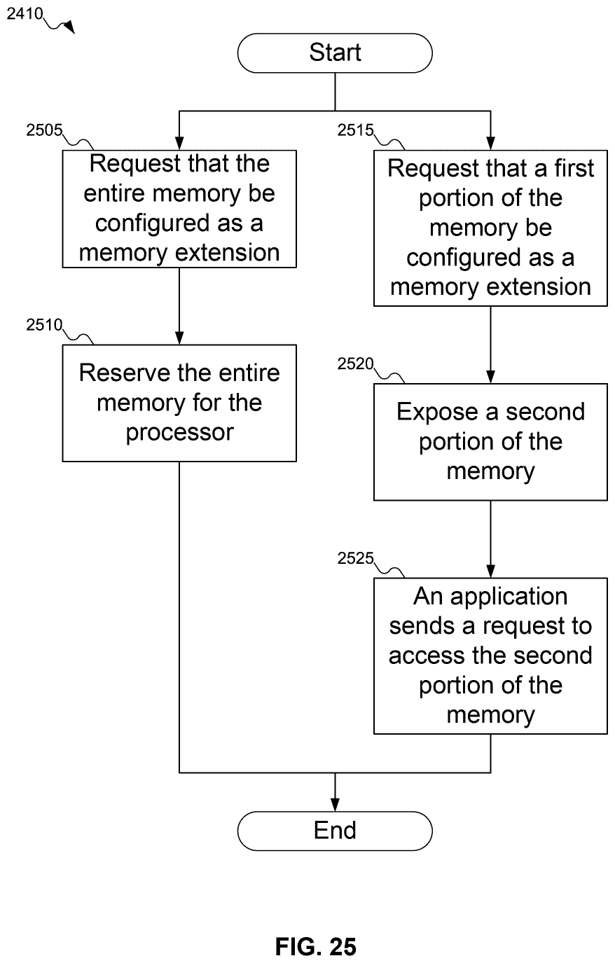

FIG. 25 shows a flowchart of an example procedure for processor 110 of FIG. 1 to request that device 120 of FIG. 1 configure itself as a memory extension for use as a swap space for memory 115 of FIG. 1, according to embodiments of the disclosure. In FIG. 25, at block 2505, processor 110 of FIG. 1 may request that device 120 of FIG. 1 configure itself entirely as a memory extension for use by processor 110 of FIG. 1. Then, at block 2510, processor 110 of

FIG. 1 may reserve the entirety of device 120 of FIG. 1 for use by processor 110 of FIG. 1 as a swap space (that is, hiding device 120 of FIG. 1 from any applications executing on processor 110 of FIG. 1).

Alternatively, at block 2515, processor 110 of FIG. 1 may request that device 120 of FIG. 1 configure only a portion of itself as a memory extension for use as a swap space by processor 110 of FIG. 1. At block 2520, processor 110 of FIG. 1 may then expose a second portion of device 120 of FIG. 1 to applications executing on processor 110 of FIG. 1 for their use (either as a memory extension or as a disk). Finally, at block 2525, an application executing on processor 110 of FIG. 1 may send a request to device 120 of FIG. 1 to access data stored on the second (exposed) portion of device 120 of FIG. 1.

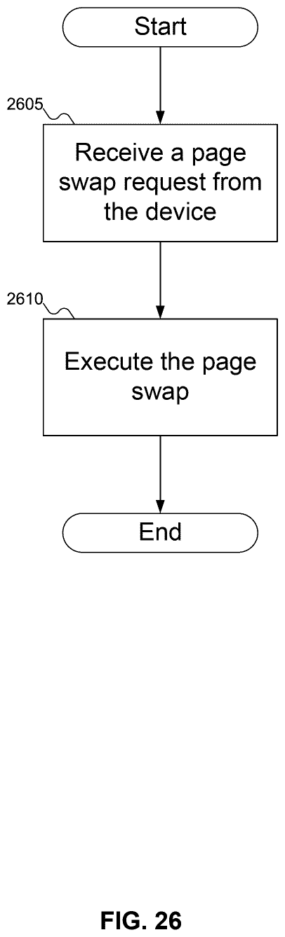

FIG. 26 shows a flowchart of an example procedure for processor 110 of FIG. 1 to process a request from device 120 of FIG. 1 to swap a page in memory 115 of FIG. 1, according to embodiments of the disclosure. At block 2605, processor 110 of FIG. 1 may receive a request from device 120 of FIG. 1 to swap one or more pages between memory 115 and device 120 of FIG. 1. At block 2610, processor 110 of FIG. 1 may then execute the requested page swap.

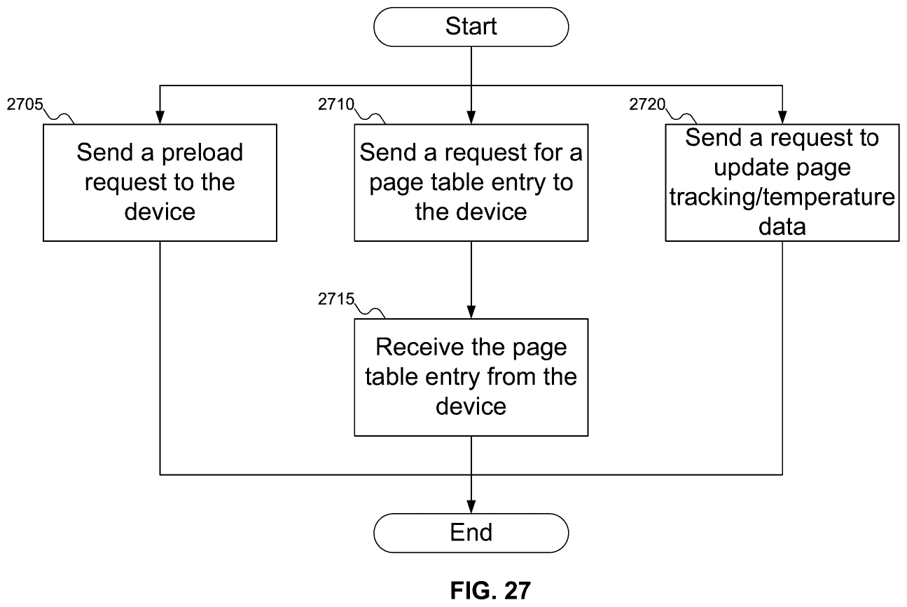

FIG. 27 shows a flowchart of an example procedure for processor 110 of FIG. 1 to send processing request 625 of FIG. 6 to device 120 of FIG. 1, according to embodiments of the disclosure. In FIG. 27, at block 2705, processor 110 of FIG. 1 may send a request that device 120 of FIG. 1 preload data from storage media 465 of FIGS. 4A-4B into device cache 425 of FIGS. 4A-4B. Alternatively, at block 2710, processor 110 of FIG. 1 may send a request for entry 325 of FIG. 3 of page table 320 of FIG. 3 to device 120, and may, at block 2715, receive in response entry 325 of FIG. 3 of page table 320 of FIG. 3. Alternatively, at block 2720, processor 110 of FIG. 1 may send a request for device 120 of FIG. 1 to update metadata 440 of FIG. 4A.

In FIGS. 7-27, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

Embodiments of the disclosure may enable the use of a device including both a storage media and a memory as a swap space for pages in memory. The device being used as a swap space may be hidden from applications. The use of the device including the memory offers a technical advantage in that memory may be accessed more quickly than other storage media, such as SSDs or hard disk drives.

The device may support page management operations, reducing the load on the processor. By offloading page management operations to the device, the load on the processor may be reduced, thereby offering a technical advantage.

Systems, methods, and apparatus in accordance with example embodiments of the disclosure may involve hosts, solid state storage devices (SSD), and SSD Controllers which use one or more methods of expanding the memory by exposing the Compute Express Link (CXL) memory as a swap space.

Some embodiments of the disclosure described herein may include various methods to expose Cxl.mem as a swap space.

According to some embodiments of the disclosure, the system may create a non-volatile region, configure it in a fsdax mode, and store the swap file on the device.

According to embodiments of the disclosure, one may modify the operating system (OS or O/S) swap management unit to manage the swap space using CXL.mem instead of a block device, for example. For example, on page fault, one may swap in the page from CXL memory device using CXL load/read transactions. When the pages are swapped out, one may use CXL store/write transactions to write the page to a CXL memory device.

According to some embodiments of the disclosure, one may use the device cache (e.g., DRAM, SRAM) as the page cache to store frequently used pages for future reference. According to some embodiments of the disclosure, some of the swap management functionalities may be offloaded to the CXL device. These functionalities may include a module that fetches the pages from SSD to the device cache. Another module may be a module that periodically flush dirty pages from page cache to the storage. In some embodiments of the disclosure, new swap functionality may replace the default swap management based on block device, for example. According to some embodiments of the disclosure, a CXL device may include a cache policy engine that uses some hardware/software counters to prefetch future accesses pages to the page cache to improve the swap performance.

According to some embodiments of the disclosure, one may modify the OS swap management unit to program/write a Direct memory access (DMA) descriptor {source page address in CXL memory device, destination physical page address in main memory, length of the page, miscellaneous information} to the CXL memory device when a page fault happens to swap in a page.

According to some embodiments of the disclosure, one may modify the OS swap management unit to program/write a DMA descriptor {source physical page address in main memory, destination page address in CXL memory device, length of the page, miscellaneous information} to the CXL memory device when an OS wants to swap out a page, for example.

According to some embodiments of the disclosure, one may create a RAM (Random Accessed Memory)-based block device based on CXL memory and use it as swap or secondary storage device. Pages written to this device may be compressed (to reduce the space) and then stored on the CXL-memory device. Upon reading, the data blocks may be decompressed and then sent to the host. Any compression algorithms such as real time data compressions, and the Lempel-Ziv-Oberhumer compression algorithm may be used. Alternatively, the compression and decompression may be offloaded to the CXL compute module and performed internally using a software or a dedicated hardware unit.

Advantages according to some embodiments include:

Expanding the memory capacity available to applications.

Reducing the total cost of ownership by providing large memory capacity with a cheaper solution like SSD.

Freeing up some of the DDR space by offloading the page cache to the CXL memory device.

Improving the memory paging (swapping) performance which results in improving the system performance under a heavy workload.

Improving the swap performance for random read/writes due to using finer granularity accesses (64-byte access with CXL compared to 4K page access of a block device, for example).

Taking advantage of active prefetching and eviction in hardware to further improve the device cache (page cache) performance.

Any of the storage devices disclosed herein may communicate through any interfaces and/or protocols including Peripheral Component Interconnect Express (PCIe), Nonvolatile Memory Express (NVMe), NVMe-over-fabric (NVMe-oF), Ethernet, Transmission Control Protocol/Internet Protocol (TCP/IP), User Datagram Protocol (UDP), remote direct memory access (RDMA), RDMA over Converged Ethernet (ROCE), FibreChannel, InfiniBand, Serial ATA (SATA), Small Computer Systems Interface (SCSI), Serial Attached SCSI (SAS), iWARP, Hypertext Transfer Protocol (HTTP), CXL, and/or the like, or any combination thereof.

Any of the functionality disclosed herein may be implemented with hardware, software, or a combination thereof including combinational logic, sequential logic, one or more timers, counters, registers, and/or state machines, one or more complex programmable logic devices (CPLDs), field programmable gate arrays (FPGAs), application specific integrated circuits (ASICs), central processing units (CPUs) such as complex instruction set computer (CISC) processors such as x86 processors and/or reduced instruction set computer (RISC) processors such as ARM processors, graphics processing units (GPUs), neural processing units (NPUs), tensor processing units (TPUs) and/or the like, executing instructions stored in any type of memory, or any combination thereof. In some embodiments, one or more components may be implemented as a system-on-chip (SOC).

In the embodiments of the disclosure described herein, the operations are example operations, and may involve various additional operations not explicitly illustrated. In some embodiments of the disclosure, some of the illustrated operations may be omitted. In some embodiments of the disclosure, one or more of the operations may be performed by components other than those illustrated herein. Additionally, in some embodiments of the disclosure, the temporal order of the operations may be varied.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Embodiments of the disclosure may extend to the following statements, without limitation:

Statement 1. An embodiment of the disclosure includes a device, comprising:
a first memory to store a data;
a controller to manage the first memory;
a storage media to store a copy of the data; and
a module to support page swapping with a second memory associated with a processor.

Statement 2. An embodiment of the disclosure includes the device according to statement 1, wherein the device includes a cache-coherent interconnect memory module.

Statement 3. An embodiment of the disclosure includes the device according to statement 2, wherein the cache-coherent interconnect memory module supports the Compute Express Link® (CXL®) protocol.

Statement 4. An embodiment of the disclosure includes the device according to statement 1, wherein the first memory is one of a volatile memory or a non-volatile memory.

Statement 5. An embodiment of the disclosure includes the device according to statement 1, wherein the storage media is one of volatile storage media and a non-volatile storage media.

Statement 6. An embodiment of the disclosure includes the device according to statement 1, wherein the device further comprises a memory unit and a storage unit, wherein:
the memory unit includes the first memory, the controller, and the module; and
the storage unit includes the storage media and a storage controller to access the data on the storage media.

Statement 7. An embodiment of the disclosure includes the device according to statement 6, wherein:
the memory unit further includes a first interface logic to interface with a second interface logic of the storage unit; and
the storage unit further includes the second interface logic to interface with the first interface logic of the memory unit.

Statement 8. An embodiment of the disclosure includes the device according to statement 1, further comprising a translation layer to translate a first address used by the processor to a second address used by the storage media.

Statement 9. An embodiment of the disclosure includes the device according to statement 8, wherein:
the storage media includes a flash storage media; and
the translation layer includes a flash translation layer.

Statement 10. An embodiment of the disclosure includes the device according to statement 1, wherein the module includes at least one of a compression/decompression unit, and encryption/decryption unit, a page selection module to select pages to move pages between the first memory and the second memory, and a preload engine.

Statement 11. An embodiment of the disclosure includes the device according to statement 1, wherein the first memory is configured to store a page table associated with the second memory.

Statement 12. An embodiment of the disclosure includes the device according to statement 1, wherein the first memory is configured to store page tracking data.

Statement 13. An embodiment of the disclosure includes the device according to statement 1, wherein:
the first memory supports access at a first granularity;
the storage media supports access at a second granularity; and
the first granularity is finer than the second granularity.

Statement 14. An embodiment of the disclosure includes the device according to statement 1, wherein the device is exposed to the processor as an extension of the second memory.

Statement 15. An embodiment of the disclosure includes the device according to statement 14, wherein the device is not exposed to an application executing on the processor.

Statement 16. An embodiment of the disclosure includes the device according to statement 1, wherein the device is exposed to the processor as a storage device.

Statement 17. An embodiment of the disclosure includes a method, comprising:
exposing, by a device, the device to a processor, the device including a first memory and a storage media;
receiving, at the device, a first request to use the first memory of the device as a disk;
configuring, by the device, the device to operate as the disk;
receiving, at the device, a second request for a data in the disk from the processor; and
processing, by the device, the second request,
wherein the processor uses the disk as a swap space for a second memory associated with the processor.

Statement 18. An embodiment of the disclosure includes the method according to statement 17, wherein the device includes a cache-coherent interconnect memory module.

Statement 19. An embodiment of the disclosure includes the method according to statement 17, wherein the cache-coherent interconnect memory module supports the Compute Express Link® (CXL®) protocol.

Statement 20. An embodiment of the disclosure includes the method according to statement 17, wherein the first memory is one of a volatile memory or a non-volatile memory.

Statement 21. An embodiment of the disclosure includes the method according to statement 17, wherein the storage media is one of volatile storage media and a non-volatile storage media.

Statement 22. An embodiment of the disclosure includes the method according to statement 17, wherein:
the first memory supports access at a first granularity;
the storage media supports access at a second granularity; and
the first granularity is finer than the second granularity.

Statement 23. An embodiment of the disclosure includes the method according to statement 17, wherein configuring, by the device, the device to operate as the disk includes configuring, by the device, the device to use the first memory as the disk.

Statement 24. An embodiment of the disclosure includes the method according to statement 23, wherein configuring, by the device, the device to operate as the disk further includes configuring, by the device, the device to use the first memory and the storage media as the disk.

Statement 25. An embodiment of the disclosure includes the method according to statement 17, wherein configuring, by the device, the device to operate as the disk includes configuring, by the device, the device to use a first portion of the first memory as the disk.

Statement 26. An embodiment of the disclosure includes the method according to statement 25, wherein configuring, by the device, the device to operate as the disk further includes configuring, by the device, the device to use a second portion of the first memory as an extension of the second memory.

Statement 27. An embodiment of the disclosure includes the method according to statement 25, wherein configuring, by the device, the device to operate as the disk further includes configuring, by the device, the device to use a second portion of the first memory as a second disk.

Statement 28. An embodiment of the disclosure includes the method according to statement 27, wherein configuring, by the device, the device to use a second portion of the first memory as a second disk includes exposing, by the device, the second disk to the host processor.

Statement 29. An embodiment of the disclosure includes the method according to statement 28, wherein exposing, by the device, the second disk to the host processor includes exposing, by the device, the second disk to the host processor for use by an application executing on the processor.

Statement 30. An embodiment of the disclosure includes the method according to statement 17, wherein:
receiving, at the device, the second request for data in the disk from the processor includes:
   receiving, at the device, a read request for the data from the processor, the read request including an address; and
   reading, by the device, the data from the first memory based at least in part on the address; and
processing, by the device, the second request includes sending, from the device to the processor, the data to the second memory.

Statement 31. An embodiment of the disclosure includes the method according to statement 17, wherein:
receiving, at the device, the second request for data in the disk from the processor includes receiving, by the device, a write request for the data from the processor, the write request including the data and an address; and
processing, by the device, the second request includes storing, by the device, the data into the first memory at the address.

Statement 32. An embodiment of the disclosure includes the method according to statement 31, wherein processing, by the device, the second request further includes sending, from the device to the processor, a result.

Statement 33. An embodiment of the disclosure includes a method, comprising:
receiving, at a processor, a notification that a device is available, the device including a first memory and a storage media;
sending, from the processor to the device, a first request for the device to configure itself as a disk; and
sending, from the processor to the device, a second request for a data in the disk,
wherein the processor uses the disk as a swap space for a second memory associated with the processor.

Statement 34. An embodiment of the disclosure includes the method according to statement 33, wherein the device includes a cache-coherent interconnect memory module.

Statement 35. An embodiment of the disclosure includes the method according to statement 34, wherein the cache-coherent interconnect memory module supports the Compute Express Link® (CXL®) protocol.

Statement 36. An embodiment of the disclosure includes the method according to statement 33, wherein the first memory is one of a volatile memory or a non-volatile memory.

Statement 37. An embodiment of the disclosure includes the method according to statement 33, wherein the storage media is one of volatile storage media and a non-volatile storage media.

Statement 38. An embodiment of the disclosure includes the method according to statement 33, wherein:
the first memory supports access at a first granularity;
the storage media supports access at a second granularity; and
the first granularity is finer than the second granularity.

Statement 39. An embodiment of the disclosure includes the method according to statement 33, wherein:
sending, from the processor to the device, the first request for the device to configure itself as the disk includes sending, from the processor to the device, the first request for the device to configure the first memory as the disk.

Statement 40. An embodiment of the disclosure includes the method according to statement 33, wherein:
sending, from the processor to the device, the first request for the device to configure itself as the disk includes sending, from the processor to the device, the first request for the device to configure a first portion of the first memory as the disk; and
the method further comprises sending, from an application executing on the processor to the device, a third request to access data from a second portion of the first memory of the device.

Statement 41. An embodiment of the disclosure includes the method according to statement 40, further comprising exposing, by the processor, the second portion of the first memory of the device as a second disk.

Statement 42. An embodiment of the disclosure includes the method according to statement 40, further comprising exposing, by the processor, the second portion of the first memory of the device as a third memory.

Statement 43. An embodiment of the disclosure includes the method according to statement 42, wherein exposing, by the processor, the second portion of the first memory of the device as a third memory includes exposing, by the processor, the third memory as an extension of the second memory.

Statement 44. An embodiment of the disclosure includes the method according to statement 40, further comprising receiving, at the application executing on the processor, a response to the third request.

Statement 45. An embodiment of the disclosure includes the method according to statement 33, wherein:
sending, from the processor to the device, the second request for the data in the disk includes sending, from the processor to the device, a read request for the data in the disk, the read request including an address; and
the method further comprises receiving, at the processor from the device, the data.

Statement 46. An embodiment of the disclosure includes the method according to statement 33, wherein:
sending, from the processor to the device, the second request for the data in the disk includes sending, from the processor to the device, a write request for the data in the disk, the write request including the data and an address; and
the method further comprises receiving, at the processor from the device, a response that the data has been written to the disk.

Statement 47. An embodiment of the disclosure includes a method, comprising:
exposing, by a device, the device to a processor, the device including a first memory and a storage media;
receiving, at the device, a first request to use the memory of the device as a memory device;
configuring, by the device, the device to operate as an extension of a second memory associated with the processor;
receiving, at the device from the processor, a second request for a data in the device; and
processing, by the device, the second request,
wherein the processor uses the memory device as a swap space for the second memory.

Statement 48. An embodiment of the disclosure includes the method according to statement 47, wherein the device includes a cache-coherent interconnect memory module.

Statement 49. An embodiment of the disclosure includes the method according to statement 48, wherein the cache-coherent interconnect memory module supports the Compute Express Link® (CXL®) protocol.

Statement 50. An embodiment of the disclosure includes the method according to statement 47, wherein the first memory is one of a volatile memory or a non-volatile memory.

Statement 51. An embodiment of the disclosure includes the method according to statement 47, wherein the storage media is one of volatile storage media and a non-volatile storage media.

Statement 52. An embodiment of the disclosure includes the method according to statement 47, wherein:
the first memory supports access at a first granularity;
the storage media supports access at a second granularity; and
the first granularity is finer than the second granularity.

Statement 53. An embodiment of the disclosure includes the method according to statement 47, wherein configuring, by the device, the device to operate as the extension of the second memory associated with the processor includes configuring, by the device, the device to use the first memory as the extension of the second memory.

Statement 54. An embodiment of the disclosure includes the method according to statement 47, wherein configuring, by the device, the device to operate as the extension of the second memory associated with the processor includes configuring, by the device, a first portion of the first memory to operate as the extension of the second memory.

Statement 55. An embodiment of the disclosure includes the method according to statement 54, wherein configuring, by the device, the device to operate as the extension of the second memory associated with the processor further includes configuring, by the device, a second portion of the first memory to operate as a second extension of the second memory.

Statement 56. An embodiment of the disclosure includes the method according to statement 55, configuring, by the device, the device to operate as the extension of the second memory associated with the processor further includes exposing, by the device, the second portion of the memory to the host processor.

Statement 57. An embodiment of the disclosure includes the method according to statement 47, further comprising executing, by the device, an algorithm to select the data to swap between the first memory and the second memory.

Statement 58. An embodiment of the disclosure includes the method according to statement 47, wherein:
receiving, at the device from the processor, the second request for the data in the device includes receiving, at the device from the processor, a read request, the read request including an address; and
processing, by the device, the second request includes:
   reading, by the device, the data from the first memory based at least in part on the address; and
   sending, from the device to the processor, the data to the second memory.

Statement 59. An embodiment of the disclosure includes the method according to statement 58, wherein:
reading, by the device, the data from the first memory based at least in part on the address includes reading, by the device, a compressed data from the first memory based at least in part on the address; and
processing, by the device, the second request further includes decompressing, by the device, the compressed data to produce the data.

Statement 60. An embodiment of the disclosure includes the method according to statement 58, wherein:
reading, by the device, the data from the first memory based at least in part on the address includes reading, by the device, an encrypted data from the first memory based at least in part on the address; and
processing, by the device, the second request further includes decrypting, by the device, the encrypted data to produce the data.

Statement 61. An embodiment of the disclosure includes the method according to statement 58, wherein sending, from the device to the processor, the data to the second memory includes executing, by the device, a direct memory access (DMA) command to write the data to the second memory.

Statement 62. An embodiment of the disclosure includes the method according to statement 47, wherein:
receiving, at the device from the processor, the second request for the data in the device includes receiving, at the device from the processor, a write request for the data, the write request including the data and an address; and
processing, by the device, the second request includes storing, by the device, the data in the first memory based at least in part on the address.

Statement 63. An embodiment of the disclosure includes the method according to statement 62, wherein:
processing, by the device, the second request includes compressing the data to produce a compressed data; and
storing, by the device, the data in the first memory at the address includes storing, by the device, the compressed data in the first memory based at least in part on the address.

Statement 64. An embodiment of the disclosure includes the method according to statement 62, wherein:
processing, by the device, the second request includes encrypting the data to produce an encrypted data; and
storing, by the device, the data in the first memory at the address includes storing, by the device, the encrypted data in the first memory based at least in part on the address.

Statement 65. An embodiment of the disclosure includes the method according to statement 62, wherein receiving, at the device from the processor, the second request for the data in the device includes executing, by the device, a direct memory access (DMA) command to read the data from the second memory.

Statement 66. An embodiment of the disclosure includes the method according to statement 62, wherein processing, by the device, the second request further includes sending, from the device to the processor, a completion result.

Statement 67. An embodiment of the disclosure includes the method according to statement 47, wherein:
receiving, at the device from the processor, the second request for the data in the device includes receiving, at the device from the processor, a preload request, the preload request identifying at least a second data; and
processing, by the device, the second request includes:
   reading, by the device, the second data from the storage media; and
   storing, by the device, the second data in the first memory.

Statement 68. An embodiment of the disclosure includes the method according to statement 47, wherein:
the first memory is configured to store a page table associated with the second memory;
receiving, at the device from the processor, the second request for the data in the device includes receiving, at the device from the processor, a request for an entry in a page table; and
processing, by the device, the second request includes:
   identifying, by the device, the entry in the page table stored in the first memory; and
   sending, from the device to the processor, the entry in the page table stored in the first memory.

Statement 69. An embodiment of the disclosure includes the method according to statement 47, wherein:
the first memory is configured to store a page tracking data;
receiving, at the device from the processor, the second request for the data in the device includes receiving, at the device from the processor, an update request for the page tracking data; and
processing, by the device, the second request includes updating the page tracking data based at least in part on the update request.

Statement 70. An embodiment of the disclosure includes the method according to statement 69, wherein:
the page tracking data includes page temperature data; and
processing, by the device, the second request includes updating the page temperature data based at least in part on the update request.

Statement 71. An embodiment of the disclosure includes a method, comprising:
receiving, at a processor, a notification that a device is available, the device including a first memory and a storage media;
sending, from the processor to the device, a first request for the device to configure itself as a memory device; and
sending, from the processor to the device, a second request for a data in the memory device,
wherein the device includes a first memory and a storage media,
and wherein the processor uses the disk as a swap space for a second memory associated with the processor.

Statement 72. An embodiment of the disclosure includes the method according to statement 71, wherein the device includes a cache-coherent interconnect memory module.

Statement 73. An embodiment of the disclosure includes the method according to statement 72, wherein the cache-coherent interconnect memory module supports the Compute Express Link® (CXL®) protocol.

Statement 74. An embodiment of the disclosure includes the method according to statement 71, wherein the first memory is one of a volatile memory or a non-volatile memory.

Statement 75. An embodiment of the disclosure includes the method according to statement 71, wherein the storage media is one of volatile storage media and a non-volatile storage media.

Statement 76. An embodiment of the disclosure includes the method according to statement 71, wherein:
the first memory supports access at a first granularity;
the storage media supports access at a second granularity; and
the first granularity is finer than the second granularity.

Statement 77. An embodiment of the disclosure includes the method according to statement 71, further comprising reserving the device for use by the processor.

Statement 78. An embodiment of the disclosure includes the method according to statement 71, wherein:
sending, from the processor to the device, the first request for the device to configure itself as the memory device includes sending, from the processor to the device, the first request for the device to configure a first portion of the first memory as the memory device; and
the method further comprises sending, from an application executing on the processor, a third request to access data from a second portion of the first memory.

Statement 79. An embodiment of the disclosure includes the method according to statement 78, further comprising exposing, by the processor, the second portion of the first memory to the application executing on the processor.

Statement 80. An embodiment of the disclosure includes the method according to statement 78, further comprising receiving, at the application executing on the processor, a response to the third request.

Statement 81. An embodiment of the disclosure includes the method according to statement 71, further comprising receiving, at the processor from the device, a swap request to swap the data between the first memory and the second memory.

Statement 82. An embodiment of the disclosure includes the method according to statement 71, wherein:
sending, from the processor to the device, a second request for a data in the memory device includes sending, from the processor to the device, a read request, the read request including an address; and
the method further comprises receiving, at the processor from the device, the data.

Statement 83. An embodiment of the disclosure includes the method according to statement 82, further comprising executing, by the device, a direct memory access (DMA) command to write the data to the second memory.

Statement 84. An embodiment of the disclosure includes the method according to statement 71, wherein sending, from the processor to the device, a second request for a data in the memory device includes sending, from the processor to the device, a write request, the write request including the data and an address.

Statement 85. An embodiment of the disclosure includes the method according to statement 84, wherein executing, by the device, a direct memory access (DMA) command to read the data from the second memory.

Statement 86. An embodiment of the disclosure includes the method according to statement 84, wherein processing, by the device, the second request further includes receiving, at the processor from the device, a completion result.

Statement 87. An embodiment of the disclosure includes the method according to statement 71, wherein sending, from the processor to the device, a second request for a data in the memory device includes sending, from the processor to the device, a preload request, the preload request identifying at least a second data.

Statement 88. An embodiment of the disclosure includes the method according to statement 71, wherein:
the first memory is configured to store a page table associated with the second memory;
sending, from the processor to the device, a second request for a data in the memory device includes sending, from the processor to the device, a request for an entry in a page table; and
the method further comprises receiving, at the processor from the device, the entry in the page table.

Statement 89. An embodiment of the disclosure includes the method according to statement 71, wherein:
the first memory is configured to store a page tracking data;
sending, from the processor to the device, a second request for a data in the memory device includes sending, from the processor to the device, an update request for the page tracking data.

Statement 90. An embodiment of the disclosure includes the method according to statement 89, wherein the page tracking data includes page temperature data.

Statement 91. An embodiment of the disclosure includes a system, comprising a non-transitory storage medium, the non-transitory storage medium having stored thereon instructions that, when executed by a machine, result in:
exposing, by a device, the device to a processor, the device including a first memory and a storage media;
receiving, at the device, a first request to use the first memory of the device as a disk;
configuring, by the device, the device to operate as the disk;
receiving, at the device, a second request for a data in the disk from the processor; and
processing, by the device, the second request,
wherein the processor uses the disk as a swap space for a second memory associated with the processor.

Statement 92. An embodiment of the disclosure includes the system according to statement 91, wherein the device includes a cache-coherent interconnect memory module.

Statement 93. An embodiment of the disclosure includes the system according to statement 91, wherein the cache-coherent interconnect memory module supports the Compute Express Link® (CXL®) protocol.

Statement 94. An embodiment of the disclosure includes the system according to statement 91, wherein the first memory is one of a volatile memory or a non-volatile memory.

Statement 95. An embodiment of the disclosure includes the system according to statement 91, wherein the storage media is one of volatile storage media and a non-volatile storage media.

Statement 96. An embodiment of the disclosure includes the system according to statement 91, wherein:
the first memory supports access at a first granularity;
the storage media supports access at a second granularity; and
the first granularity is finer than the second granularity.

Statement 97. An embodiment of the disclosure includes the system according to statement 91, wherein configuring, by the device, the device to operate as the disk includes configuring, by the device, the device to use the first memory as the disk.

Statement 98. An embodiment of the disclosure includes the system according to statement 97, wherein configuring, by the device, the device to operate as the disk further includes configuring, by the device, the device to use the first memory and the storage media as the disk.

Statement 99. An embodiment of the disclosure includes the system according to statement 91, wherein configuring, by the device, the device to operate as the disk includes configuring, by the device, the device to use a first portion of the first memory as the disk.

Statement 100. An embodiment of the disclosure includes the system according to statement 99, wherein configuring, by the device, the device to operate as the disk further includes configuring, by the device, the device to use a second portion of the first memory as an extension of the second memory.

Statement 101. An embodiment of the disclosure includes the system according to statement 99, wherein configuring, by the device, the device to operate as the disk further includes configuring, by the device, the device to use a second portion of the first memory as a second disk.

Statement 102. An embodiment of the disclosure includes the system according to statement 101, wherein configuring, by the device, the device to use a second portion of the first memory as a second disk includes exposing, by the device, the second disk to the host processor.

Statement 103. An embodiment of the disclosure includes the system according to statement 102, wherein exposing, by the device, the second disk to the host processor includes exposing, by the device, the second disk to the host processor for use by an application executing on the processor.

Statement 104. An embodiment of the disclosure includes the system according to statement 91, wherein:
receiving, at the device, the second request for data in the disk from the processor includes:
   receiving, at the device, a read request for the data from the processor, the read request including an address; and
   reading, by the device, the data from the first memory based at least in part on the address; and
processing, by the device, the second request includes sending, from the device to the processor, the data to the second memory.

Statement 105. An embodiment of the disclosure includes the system according to statement 91, wherein:
receiving, at the device, the second request for data in the disk from the processor includes receiving, by the device, a write request for the data from the processor, the write request including the data and an address; and
processing, by the device, the second request includes storing, by the device, the data into the first memory at the address.

Statement 106. An embodiment of the disclosure includes the system according to statement 105, wherein processing, by the device, the second request further includes sending, from the device to the processor, a result.

Statement 107. An embodiment of the disclosure includes a system, comprising a non-transitory storage medium, the non-transitory storage medium having stored thereon instructions that, when executed by a machine, result in:
receiving, at a processor, a notification that a device is available, the device including a first memory and a storage media;
sending, from the processor to the device, a first request for the device to configure itself as a disk; and
sending, from the processor to the device, a second request for a data in the disk,
wherein the processor uses the disk as a swap space for a second memory associated with the processor.

Statement 108. An embodiment of the disclosure includes the system according to statement 107, wherein the device includes a cache-coherent interconnect memory module.

Statement 109. An embodiment of the disclosure includes the system according to statement 108, wherein the cache-coherent interconnect memory module supports the Compute Express Link® (CXL®) protocol.

Statement 110. An embodiment of the disclosure includes the system according to statement 107, wherein the first memory is one of a volatile memory or a non-volatile memory.

Statement 111. An embodiment of the disclosure includes the system according to statement 107, wherein the storage media is one of volatile storage media and a non-volatile storage media.

Statement 112. An embodiment of the disclosure includes the system according to statement 107, wherein:
the first memory supports access at a first granularity;
the storage media supports access at a second granularity; and
the first granularity is finer than the second granularity.

Statement 113. An embodiment of the disclosure includes the system according to statement 107, wherein:
sending, from the processor to the device, the first request for the device to configure itself as the disk includes sending, from the processor to the device, the first request for the device to configure the first memory as the disk.

Statement 114. An embodiment of the disclosure includes the system according to statement 107, wherein:
sending, from the processor to the device, the first request for the device to configure itself as the disk includes sending, from the processor to the device, the first request for the device to configure a first portion of the first memory as the disk; and
the non-transitory storage medium has stored thereon further instructions that, when executed by the machine, result in sending, from an application executing on the processor to the device, a third request to access data from a second portion of the first memory of the device.

Statement 115. An embodiment of the disclosure includes the system according to statement 114, the non-transitory storage medium having stored thereon further instructions that, when executed by the machine, result in exposing, by the processor, the second portion of the first memory of the device as a second disk.

Statement 116. An embodiment of the disclosure includes the system according to statement 114, the non-transitory storage medium having stored thereon further instructions that, when executed by the machine, result in exposing, by the processor, the second portion of the first memory of the device as a third memory.

Statement 117. An embodiment of the disclosure includes the system according to statement 116, wherein exposing, by the processor, the second portion of the first memory of the device as a third memory includes exposing, by the processor, the third memory as an extension of the second memory.

Statement 118. An embodiment of the disclosure includes the system according to statement 114, the non-transitory storage medium having stored thereon further instructions that, when executed by the machine, result in receiving, at the application executing on the processor, a response to the third request.

Statement 119. An embodiment of the disclosure includes the system according to statement 107, wherein:
sending, from the processor to the device, the second request for the data in the disk includes sending, from the processor to the device, a read request for the data in the disk, the read request including an address; and
the non-transitory storage medium has stored thereon further instructions that, when executed by the machine, result in receiving, at the processor from the device, the data.

Statement 120. An embodiment of the disclosure includes the system according to statement 107, wherein:
sending, from the processor to the device, the second request for the data in the disk includes sending, from the processor to the device, a write request for the data in the disk, the write request including the data and an address; and
the non-transitory storage medium has stored thereon further instructions that, when executed by the machine, result in receiving, at the processor from the device, a response that the data has been written to the disk.

Statement 121. An embodiment of the disclosure includes a system, comprising a non-transitory storage medium, the non-transitory storage medium having stored thereon instructions that, when executed by a machine, result in:
exposing, by a device, the device to a processor, the device including a first memory and a storage media;
receiving, at the device, a first request to use the memory of the device as a memory device;
configuring, by the device, the device to operate as an extension of a second memory associated with the processor;
receiving, at the device from the processor, a second request for a data in the device; and
processing, by the device, the second request,
wherein the processor uses the memory device as a swap space for the second memory.

Statement 122. An embodiment of the disclosure includes the system according to statement 121, wherein the device includes a cache-coherent interconnect memory module.

Statement 123. An embodiment of the disclosure includes the system according to statement 122, wherein the cache-coherent interconnect memory module supports the Compute Express Link® (CXL®) protocol.

Statement 124. An embodiment of the disclosure includes the system according to statement 121, wherein the first memory is one of a volatile memory or a non-volatile memory.

Statement 125. An embodiment of the disclosure includes the system according to statement 121, wherein the storage media is one of volatile storage media and a non-volatile storage media.

Statement 126. An embodiment of the disclosure includes the system according to statement 121, wherein:
the first memory supports access at a first granularity;
the storage media supports access at a second granularity; and
the first granularity is finer than the second granularity.

Statement 127. An embodiment of the disclosure includes the system according to statement 121, wherein configuring, by the device, the device to operate as the extension of the second memory associated with the processor includes configuring, by the device, the device to use the first memory as the extension of the second memory.

Statement 128. An embodiment of the disclosure includes the system according to statement 121, wherein configuring, by the device, the device to operate as the extension of the second memory associated with the processor includes configuring, by the device, a first portion of the first memory to operate as the extension of the second memory.

Statement 129. An embodiment of the disclosure includes the system according to statement 128, wherein configuring, by the device, the device to operate as the extension of the second memory associated with the processor further includes configuring, by the device, a second portion of the first memory to operate as a second extension of the second memory.

Statement 130. An embodiment of the disclosure includes the system according to statement 129, configuring, by the device, the device to operate as the extension of the second memory associated with the processor further includes exposing, by the device, the second portion of the memory to the host processor.

Statement 131. An embodiment of the disclosure includes the system according to statement 121, the non-transitory storage medium having stored thereon further instructions that, when executed by the machine, result in executing, by the device, an algorithm to select the data to swap between the first memory and the second memory.

Statement 132. An embodiment of the disclosure includes the system according to statement 121, wherein:
receiving, at the device from the processor, the second request for the data in the device includes receiving, at the device from the processor, a read request, the read request including an address; and
processing, by the device, the second request includes:
   reading, by the device, the data from the first memory based at least in part on the address; and
   sending, from the device to the processor, the data to the second memory.

Statement 133. An embodiment of the disclosure includes the system according to statement 132, wherein:
reading, by the device, the data from the first memory based at least in part on the address includes reading, by the device, a compressed data from the first memory based at least in part on the address; and
processing, by the device, the second request further includes decompressing, by the device, the compressed data to produce the data.

Statement 134. An embodiment of the disclosure includes the system according to statement 132, wherein:
reading, by the device, the data from the first memory based at least in part on the address includes reading, by the device, an encrypted data from the first memory based at least in part on the address; and
processing, by the device, the second request further includes decrypting, by the device, the encrypted data to produce the data.

Statement 135. An embodiment of the disclosure includes the system according to statement 132, wherein sending, from the device to the processor, the data to the second memory includes executing, by the device, a direct memory access (DMA) command to write the data to the second memory.

Statement 136. An embodiment of the disclosure includes the system according to statement 121, wherein:
receiving, at the device from the processor, the second request for the data in the device includes receiving, at the device from the processor, a write request for the data, the write request including the data and an address; and
processing, by the device, the second request includes storing, by the device, the data in the first memory based at least in part on the address.

Statement 137. An embodiment of the disclosure includes the system according to statement 136, wherein:
processing, by the device, the second request includes compressing the data to produce a compressed data; and
storing, by the device, the data in the first memory at the address includes storing, by the device, the compressed data in the first memory based at least in part on the address.

Statement 138. An embodiment of the disclosure includes the system according to statement 136, wherein:
processing, by the device, the second request includes encrypting the data to produce an encrypted data; and
storing, by the device, the data in the first memory at the address includes storing, by the device, the encrypted data in the first memory based at least in part on the address.

Statement 139. An embodiment of the disclosure includes the system according to statement 136, wherein receiving, at the device from the processor, the second request for the data in the device includes executing, by the device, a direct memory access (DMA) command to read the data from the second memory.

Statement 140. An embodiment of the disclosure includes the system according to statement 136, wherein processing, by the device, the second request further includes sending, from the device to the processor, a completion result.

Statement 141. An embodiment of the disclosure includes the system according to statement 121, wherein:
receiving, at the device from the processor, the second request for the data in the device includes receiving, at the device from the processor, a preload request, the preload request identifying at least a second data; and
processing, by the device, the second request includes:
   reading, by the device, the second data from the storage media; and
   storing, by the device, the second data in the first memory.

Statement 142. An embodiment of the disclosure includes the system according to statement 121, wherein:
the first memory is configured to store a page table associated with the second memory;
receiving, at the device from the processor, the second request for the data in the device includes receiving, at the device from the processor, a request for an entry in a page table; and
processing, by the device, the second request includes:
   identifying, by the device, the entry in the page table stored in the first memory; and
   sending, from the device to the processor, the entry in the page table stored in the first memory.

Statement 143. An embodiment of the disclosure includes the system according to statement 121, wherein:
the first memory is configured to store a page tracking data;
receiving, at the device from the processor, the second request for the data in the device includes receiving, at the device from the processor, an update request for the page tracking data; and
processing, by the device, the second request includes updating the page tracking data based at least in part on the update request.

Statement 144. An embodiment of the disclosure includes the system according to statement 143, wherein:
the page tracking data includes page temperature data; and
processing, by the device, the second request includes updating the page temperature data based at least in part on the update request.

Statement 145. An embodiment of the disclosure includes a system, comprising a non-transitory storage medium, the non-transitory storage medium having stored thereon instructions that, when executed by a machine, result in:
receiving, at a processor, a notification that a device is available, the device including a first memory and a storage media;
sending, from the processor to the device, a first request for the device to configure itself as a memory device; and
sending, from the processor to the device, a second request for a data in the memory device,
wherein the device includes a first memory and a storage media,
and wherein the processor uses the disk as a swap space for a second memory associated with the processor.

Statement 146. An embodiment of the disclosure includes the system according to statement 145, wherein the device includes a cache-coherent interconnect memory module.

Statement 147. An embodiment of the disclosure includes the system according to statement 146, wherein the cache-coherent interconnect memory module supports the Compute Express Link® (CXL®) protocol.

Statement 148. An embodiment of the disclosure includes the system according to statement 145, wherein the first memory is one of a volatile memory or a non-volatile memory.

Statement 149. An embodiment of the disclosure includes the system according to statement 145, wherein the storage media is one of volatile storage media and a non-volatile storage media.

Statement 150. An embodiment of the disclosure includes the system according to statement 145, wherein:
the first memory supports access at a first granularity;
the storage media supports access at a second granularity; and
the first granularity is finer than the second granularity.

Statement 151. An embodiment of the disclosure includes the system according to statement 145, the non-transitory storage medium having stored thereon further instructions that, when executed by the machine, result in reserving the device for use by the processor.

Statement 152. An embodiment of the disclosure includes the system according to statement 145, wherein:
sending, from the processor to the device, the first request for the device to configure itself as the memory device includes sending, from the processor to the device, the first request for the device to configure a first portion of the first memory as the memory device; and
the non-transitory storage medium has stored thereon further instructions that, when executed by the machine, result in sending, from an application executing on the processor, a third request to access data from a second portion of the first memory.

Statement 153. An embodiment of the disclosure includes the system according to statement 152, the non-transitory storage medium having stored thereon further instructions that, when executed by the machine, result in exposing, by the processor, the second portion of the first memory to the application executing on the processor.

Statement 154. An embodiment of the disclosure includes the system according to statement 152, the non-transitory storage medium having stored thereon further instructions that, when executed by the machine, result in receiving, at the application executing on the processor, a response to the third request.

Statement 155. An embodiment of the disclosure includes the system according to statement 145, the non-transitory storage medium having stored thereon further instructions that, when executed by the machine, result in receiving, at the processor from the device, a swap request to swap the data between the first memory and the second memory.

Statement 156. An embodiment of the disclosure includes the system according to statement 145, wherein:
sending, from the processor to the device, a second request for a data in the memory device includes sending, from the processor to the device, a read request, the read request including an address; and
the non-transitory storage medium has stored thereon further instructions that, when executed by the machine, result in receiving, at the processor from the device, the data.

Statement 157. An embodiment of the disclosure includes the system according to statement 156, the non-transitory storage medium having stored thereon further instructions that, when executed by the machine, result in executing, by the device, a direct memory access (DMA) command to write the data to the second memory.

Statement 158. An embodiment of the disclosure includes the system according to statement 145, wherein sending, from the processor to the device, a second request for a data in the memory device includes sending, from the processor to the device, a write request, the write request including the data and an address.

Statement 159. An embodiment of the disclosure includes the system according to statement 158, wherein executing, by the device, a direct memory access (DMA) command to read the data from the second memory.

Statement 160. An embodiment of the disclosure includes the system according to statement 158, wherein processing, by the device, the second request further includes receiving, at the processor from the device, a completion result.

Statement 161. An embodiment of the disclosure includes the system according to statement 145, wherein sending, from the processor to the device, a second request for a data in the memory device includes sending, from the processor to the device, a preload request, the preload request identifying at least a second data.

Statement 162. An embodiment of the disclosure includes the system according to statement 145, wherein:
the first memory is configured to store a page table associated with the second memory;
sending, from the processor to the device, a second request for a data in the memory device includes sending, from the processor to the device, a request for an entry in a page table; and
the non-transitory storage medium has stored thereon further instructions that, when executed by the machine, result in receiving, at the processor from the device, the entry in the page table.

Statement 163. An embodiment of the disclosure includes the system according to statement 145, wherein:
the first memory is configured to store a page tracking data;
sending, from the processor to the device, a second request for a data in the memory device includes sending, from the processor to the device, an update request for the page tracking data.

Statement 164. An embodiment of the disclosure includes the system according to statement 163, wherein the page tracking data includes page temperature data.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A device, comprising:
a first memory to store a data;
a controller to manage the first memory;
a storage media to store a copy of the data; and
a module to support page swapping with a second memory associated with a processor.

2. The device according to claim 1, wherein the module includes at least one of a compression/decompression unit, and encryption/decryption unit, a page selection module to select pages to move pages between the first memory and the second memory, and a preload engine.

3. The device according to claim 1, wherein the first memory is configured to store a page table associated with the second memory.

4. The device according to claim 1, wherein the first memory is configured to store page tracking data.

5. A method, comprising:
exposing, by a device, the device to a processor, the device including a first memory and a storage media;
receiving, at the device, a first request to use the memory of the device as a memory device;
configuring, by the device, the device to operate as an extension of a second memory associated with the processor;
receiving, at the device from the processor, a second request for a data in the device; and
processing, by the device, the second request,
wherein the processor uses the memory device as a swap space for the second memory.

6. The method according to claim 5, wherein configuring, by the device, the device to operate as the extension of the second memory associated with the processor includes configuring, by the device, a first portion of the first memory to operate as the extension of the second memory.

7. The method according to claim 5, further comprising executing, by the device, an algorithm to select the data to swap between the first memory and the second memory.

8. The method according to claim 5, wherein:
receiving, at the device from the processor, the second request for the data in the device includes receiving, at the device from the processor, a read request, the read request including an address; and
processing, by the device, the second request includes:
reading, by the device, the data from the first memory based at least in part on the address; and
sending, from the device to the processor, the data to the second memory.

9. The method according to claim 8, wherein:
reading, by the device, the data from the first memory based at least in part on the address includes reading, by the device, a compressed data from the first memory based at least in part on the address; and
processing, by the device, the second request further includes decompressing, by the device, the compressed data to produce the data.

10. The method according to claim 8, wherein:
reading, by the device, the data from the first memory based at least in part on the address includes reading, by the device, an encrypted data from the first memory based at least in part on the address; and
processing, by the device, the second request further includes decrypting, by the device, the encrypted data to produce the data.

11. The method according to claim 8, wherein sending, from the device to the processor, the data to the second memory includes executing, by the device, a direct memory access (DMA) command to write the data to the second memory.

12. The method according to claim 5, wherein:
receiving, at the device from the processor, the second request for the data in the device includes receiving, at the device from the processor, a preload request, the preload request identifying at least a second data; and
processing, by the device, the second request includes:
reading, by the device, the second data from the storage media; and
storing, by the device, the second data in the first memory.

13. The method according to claim 5, wherein:
the first memory is configured to store a page table associated with the second memory;
receiving, at the device from the processor, the second request for the data in the device includes receiving, at the device from the processor, a request for an entry in a page table; and
processing, by the device, the second request includes:
identifying, by the device, the entry in the page table stored in the first memory; and
sending, from the device to the processor, the entry in the page table stored in the first memory.

14. The method according to claim 5, wherein:
the first memory is configured to store a page tracking data;
receiving, at the device from the processor, the second request for the data in the device includes receiving, at the device from the processor, an update request for the page tracking data; and
processing, by the device, the second request includes updating the page tracking data based at least in part on the update request.

15. A method, comprising:
receiving, at a processor, a notification that a device is available, the device including a first memory and a storage media;
sending, from the processor to the device, a first request for the device to configure itself as a memory device; and
sending, from the processor to the device, a second request for a data in the memory device,
wherein the device includes a first memory and a storage media,
and wherein the processor uses the disk as a swap space for a second memory associated with the processor.

16. The method according to claim 15, further comprising reserving the device for use by the processor.

17. The method according to claim 15, wherein:
sending, from the processor to the device, the first request for the device to configure itself as the memory device includes sending, from the processor to the device, the first request for the device to configure a first portion of the first memory as the memory device; and
the method further comprises
exposing, by the processor, the second portion of the first memory to an application executing on the processor.

18. The method according to claim 15, wherein sending, from the processor to the device, a second request for a data in the memory device includes sending, from the processor to the device, a preload request, the preload request identifying at least a second data.

19. The method according to claim 15, wherein:
the first memory is configured to store a page table associated with the second memory;
sending, from the processor to the device, a second request for a data in the memory device includes sending, from the processor to the device, a request for an entry in a page table; and
the method further comprises receiving, at the processor from the device, the entry in the page table.

20. The method according to claim 15, wherein:
the first memory is configured to store a page tracking data;
sending, from the processor to the device, a second request for a data in the memory device includes sending, from the processor to the device, an update request for the page tracking data.
